(19) United States
(12) Patent Application Publication
(10) Pub. No.: US 2025/0086710 A1
(43) Pub. Date: Mar. 13, 2025

(54) Method and System for Creating Non-Fungible Digital Twins (NFDT) of Objects

(71) Applicant: MVGX Tech Pte. Ltd., Singapore (SG)

(72) Inventor: Bo Bai, Beijing (CN)

(21) Appl. No.: 18/287,744

(22) PCT Filed: Apr. 21, 2022
(86) PCT No.: PCT/SG2022/050242

§ 371 Date: Oct. 20, 2023

(30) Foreign Application Priority Data
Apr. 22, 2021 (CN) 202110438834.0
Jul. 15, 2021 (WO) PCT/SG2021/050417

(51) Int. Cl. G06Q 40/04; G06Q 20/38; G06Q 30/018; H04L 9/32

(52) U.S. Cl. CPC G06Q 40/04; G06Q 20/38215; G06Q 30/018; H04L 9/3239

(57) ABSTRACT

The present application relates to systems and methods for creating Non-Fungible Digital Twins (NFDT) of objects. The objects may be digital objects or real work assets which change over time, or have properties (e.g. carbon emissions) that change over time. An initial or birth NFT smart contract is created and published which is a digital twin of the object, and as the object changes, the changes are published to subsequent NFT smart contracts with a link to the previous smart contract or the birth smart contract such that the birth smart contract and plurality of subsequent object contracts form a time series of object smart contracts which define a dynamic unique Non-Fungible Digital Twin (NFDT) representation of the object.

### CROSS REFERENCE TO RELATED APPLICATIONS

This application is the United States national phase of International Patent Application No. PCT/SG2022/050242 filed Apr. 21, 2022 and claims priority to Chinese Patent Application No. 202110438834.0 filed Apr. 22, 2021, and International Patent Application No. PCT/SG2021/050417 filed Jul. 15, 2021, the disclosures of which are hereby incorporated by reference in their entireties.

### BACKGROUND OF THE INVENTION

### Field of the Invention

The present application relates to blockchain technologies and in particular to systems and methods for representing dynamic assets on blockchains.

### Description of Related Art

In recent years there has been considerable interest in the creation of Non-Fungible Tokens (NFTs) to record ownership of digital assets such as art works and the like. For example in the Ethereum block-chain, NFTs are created using smart contracts particularly including the ERC 721 definition which creates a unique digital identifier (or token) which can be associated with a digital asset to establish (and prove) unique ownership of the digital asset. The ERC 721 definition also provides methods for transfer of the asset to another party. Other blockchains define similar smart contracts and methods for creating NFTs. There have also been some attempts to use NFTs to represent real world objects, by representing a real world object with a digital twin in the form an NFT that stores details of the object. For example in a manufacturing process, a digital twin can be created for each part to provide traceability or prove provenance.

Whilst NFTs are useful for static objects there are many objects in both the digital and real world which are dynamic and change over time. In many instances it would be useful to track the changes in these objects.

There is thus a need to provide improved systems and methods for representing dynamic objects in block-chain systems, or at least provide a useful alternative to existing methods and systems.

### SUMMARY OF THE INVENTION

According to a first aspect of the present application there is provided a method for generating a dynamic Non-Fungible Digital Twin (NFDT) representation of an asset comprising:
generating and storing an information package at a report address, wherein the information package comprises information defining a digital twin of an asset including at least one attribute value;
cryptographically signing the information package and obtaining a hash for authenticating the information package;
generating a birth asset smart contract by inputting at least an asset identifier, the report address, and the hash of the information package to an asset smart contract stored on a blockchain which publishes the birth asset smart contract to the blockchain at a birth address and contains at least the inputted information and a non fungible token generated by the asset smart contract;
generating and storing at least one subsequent information package at a subsequent report address, wherein each subsequent information package comprises information regarding the asset including either a change in the at least one attribute value of the asset, or a current value of the at least one attribute value where each subsequent information package is generated at a different time;
cryptographically signing each subsequent information package and obtaining a hash for authenticating the subsequent information package; and
generating a plurality of subsequent asset smart contracts by inputting, for each subsequent information package, at least an asset identifier, the subsequent report address, and the hash of the subsequent information package to the asset smart contract stored on a blockchain which publishes a subsequent asset smart contract to the blockchain at a subsequent address and contains at least the inputted information, a non fungible token generated by the asset smart contract and a link to an address on the blockchain of a previous asset smart contract or the birth asset smart contract such that the published birth smart contract and one or more subsequent asset contracts form a time series of asset smart contracts which define a unique Non-Fungible Digital Twin (NFDT) representation of the asset.

In one form, the report address is a Uniform Resource Identifier (URI) address or a Uniform Resource Locator (URL) address.

In one form, generating the birth asset smart contract further comprises inputting the at least one attribute value, and when generating each subsequent asset smart contract the change in the at least one attribute value of the asset, or a current value of the at least one attribute value is also input into the asset smart contract.

In one form, automated monitoring of the asset is performed to detect a change in at least one of the at least one attribute value and either periodically or on detection of a threshold change, publishing a subsequent information package containing the change in the at least one attribute value or the current value of the attribute value which triggers publishing of a subsequent asset smart contract based on the update to the attribute value.

In one form, the at least one attribute value is a tradeable characteristic of the asset.

In a further form, after each subsequent asset smart contract is published the method further comprises generating a plurality of Asset Backed Tokens (ABTs) by executing a ABT smart contract stored on the blockchain, wherein an amount of ABTs issued is determined from the change in the at least one attribute value in the asset smart contract or each ABT issued represents a fractional ownership of the NFDT and the underlying asset, and the ABT smart contract contains a link to the respective asset smart contract.

In a further form, the method further comprises storing the plurality of ABTs and offering one or more of the plurality of ABTs for trading on a trading exchange.

In a further form, the at least one attribute value is a carbon footprint of the asset and represents carbon emissions and/or carbon reductions measured in tonnes of CO2 equivalent (tCO2e), and the ABT is a carbon neutrality token (CNT) such that the NFDT is a digital twin of the underlying carbon credits applicable for trading.

In a further form, one or more of the information packages contains information regarding a carbon offsetting action in a first country, a carbon emission reduction certificate from an issuing authority in a first country in relation to the carbon offsetting action which generated an amount of verified carbon emission reductions, and a redemption certificate which prevents further trading of the carbon emission reduction certificate in an issuing country where the issuing country may be the first country or a different country. In a further form the method is implemented by a Carbon Registry which stores a plurality of NEDTs for a plurality of assets in the first country and which acts as the issuing authority.

In one form, the at least one attribute value is a carbon footprint of the asset and represents carbon emissions and/or carbon reductions measured in tonnes of CO2 equivalent (tCO2e), such that the NFDT is a digital twin of the underlying carbon neutrality status of the asset, and wherein the method is implemented by a Carbon Registry which is further configured to issue voluntary emission reduction certificates and redemption certificates to an asset owner based on the NFDT of the respective asset.

In one form the method further comprises generating a plurality of Asset Backed Tokens (ABTs) by executing an ABT smart contract stored on the blockchain, wherein the ABT contains a link to the respective asset smart contract, and one or more of the plurality of ABTs are offered for trading on a trading exchange.

In one form, each asset smart contract further includes an identifier of an owner of the asset, and one or more of the at least one attribute values includes an attribute value related to a title or other proof of ownership by the owner.

In one form, the NFDT is used to represent the asset in a Metaverse comprising a digital representation of a plurality of real world objects.

In one form, the blockchain is an Ethereum blockchain, and the asset smart contract is based on the ERC721 standard.

According to a second aspect of the present application there is a computational system comprising:
a plurality of computing apparatus comprising one or more processors, one or more memories, one or more storage devices, and one or more interfaces wherein the one or more interfaces are configured to:
generate and store an information package at a report address, wherein the information package comprises information defining a digital twin of an asset including at least one attribute value;
cryptographically signing the information package and obtaining a hash for authenticating the information package;
generating a birth asset smart contract by inputting at least an asset identifier, the report address, and the hash of the information package to an asset smart contract stored on a blockchain which publishes the birth asset smart contract to the blockchain at a birth address and contains at least the inputted information and a non fungible token generated by the asset smart contract;
generating and storing at least one subsequent information package at a subsequent report address, wherein each subsequent information package comprises information regarding the asset including either a change in the at least one attribute value of the asset, or a current value of the at least one attribute value, where each subsequent information package is generated at a different time;
cryptographically signing each subsequent information package and obtaining a hash for authenticating the subsequent information package; and
generating a plurality of subsequent asset smart contracts by inputting, for each subsequent information package, at least an asset identifier, the subsequent report address, and the hash of the subsequent information package to the asset smart contract stored on a blockchain which publishes a subsequent asset smart contract to the blockchain at a subsequent address and contains at least the inputted information, a non fungible token generated by the asset smart contract and a link to an address on the blockchain of a previous asset smart contract or the birth asset smart contract such that the published birth smart contract and one or more subsequent asset contracts form a time series of asset smart contracts which define a unique Non-Fungible Digital Twin (NFDT) representation of the asset.

In one form, the report address is a Uniform Resource Identifier (URI) address or a Uniform Resource Locator (URL) address.

In one form, generating the birth asset smart contract further comprises inputting the at least one attribute value, and when generating each subsequent asset smart contract the change in the at least one attribute value of the asset, or a current value of the at least one attribute value is also input into the asset smart contract.

In one form, the one or more interfaces are further configured to periodically receive a change in the at least one attribute value or the current value of the attribute value from an automated monitoring system which monitors the asset and on receipt the one or more interfaces are configured to publish the subsequent information package containing the change in the at least one attribute value or the current value of the attribute value.

In one form, the system further comprises the automated monitoring system and the automated monitoring system is a secure data acquisition system comprising a plurality of hardware and software components which are configured to securely monitor the asset.

In one form, the at least one attribute value is a tradeable characteristic of the asset.

In a further form, after each subsequent asset smart contract is published the system is further configured to generate a plurality of Asset Backed Tokens (ABTs) by executing a ABT smart contract stored on the blockchain, wherein an amount of ABTs issued is determined from the change in the at least one attribute value in the asset smart contract or each ABT issued represents a fractional ownership of the NFDT.

In a further form, the system further comprises a trading system implementing a ledger and cold wallet, wherein the trading system is configured to store the ABTs and facilitate trading of the ABTs between multiple parties.

In a further form, the at least one attribute value is a carbon footprint of the asset and represents carbon emissions and/or carbon reductions measured in tonnes of CO2 equivalent (tCO2c), and the ABT is a carbon neutrality token (CNT) such that the NFDT is a digital twin of the underlying carbon credits applicable for trading.

In a further form, one or more of the information packages contains information regarding a carbon offsetting action in a first country, a carbon emission reduction certificate from an issuing authority in a first country in relation to the carbon offsetting action which generated an amount of verified carbon emission reductions, and a redemption certificate which prevents further trading of the carbon emission reduction certificate in an issuing country where the issuing country may be the first country or a different country. In a further form the system is a Carbon Registry which is configured to store a plurality of NFDTs for a plurality of assets in the first country and which acts as the issuing authority.

In one form, the at least one attribute value is a carbon footprint of the asset and represents carbon emissions and/or carbon reductions measured in tonnes of CO2 equivalent (tCO2c), such that the NFDT is a digital twin of the underlying carbon neutrality status of the asset, and the computational system forms part of a Carbon Registry which is configured to issue voluntary emission reduction certificates and redemption certificates to an asset owner based on the NFDT of the respective asset.

In one form, the system is further configured to generate a plurality of Asset Backed Tokens (ABTs) by executing a ABT smart contract stored on the blockchain, wherein the ABT contains a link to the respective asset smart contract, and the system further comprises a trading system implementing a ledger and cold wallet, wherein the trading system is configured to store the ABTs and facilitate trading of the ABTs between multiple parties.

In one form, each asset smart contract further includes an identifier of an owner of the asset and one or more of the at least one attribute values includes an attribute value related to a title or other proof of ownership by the owner.

In one form, the NFDT is used to represent the asset in a Metaverse comprising a digital representation of a plurality of real world objects.

In one form, the system further comprises the blockchain.

In one form, the blockchain is an Ethereum blockchain, and the asset smart contract is based on the ERC721 standard.

According to a third aspect of the present application there is provided a computer readable storage medium having a computer program stored thereon, the computer program implementing the method according to the first aspect when executed by one or more processors.

### BRIEF DESCRIPTION OF THE DRAWINGS

Preferred embodiments of the present application will be described in further detail in conjunction with the accompanying drawings, specifically,

FIG. 1A is a flowchart of a method for generating a dynamic Non-Fungible Digital Twin (NFDT) representation of an asset according to an embodiment;

FIG. 1B is an architectural diagram of an asset trading system according to an embodiment;

FIG. 1C is a plot of the carbon footprint attribute value (ENV, in units of tCO2e) over time which is bound or associated with a Non-Fungible Digital Twin (NFDT) representation of the asset according to an embodiment;

FIG. 1D is a schematic diagram representing a linked chain of smart contracts used to digitally represent the time evolution, including potential change in carbon footprint, of an asset over time according to an embodiment;

FIG. 1E is a schematic diagram of a method for generating emission reduction smart contracts and carbon neutrality tokens (CNTs) in respect of an offsetting action to create a Non-Fungible Digital Twin (NFDT) representation of the offsetting action according to an embodiment;

FIG. 2A is a flowchart of a method for creating an NFDT and ABTs according to an embodiment;

FIG. 2B is a schematic diagram of an asset owner with a positive environmental footprint (positive ENV) which is used to generate carbon neutrality tokens (CNTs) according to an embodiment;

FIG. 2C is a schematic diagram of an asset owner with a positive environmental footprint (positive ENV) which is used to generate voluntary emission reduction certificates which are sold to a purchaser who uses the voluntary emission reduction certificates to obtain carbon neutrality tokens (CNTs) and generate an NFDT representing the asset according to an embodiment;

FIG. 2D is a schematic diagram of an asset owner with a negative environmental footprint (negative ENV; i.e. generates carbon emissions) which is listed on a digital asset trading exchange, in which the negative carbon footprint can be offset by also purchasing CNTs according to an embodiment;

FIG. 2E is a flowchart of a method for creating an NFDT for representing an asset with a positive environmental footprint (positive ENV) according to an embodiment;

FIG. 2F is a flowchart of a method for creating an NFDT for representing an asset with a negative environmental footprint (negative ENV) according to an embodiment;

FIG. 3 is a schematic diagram of a secure computing apparatus (or computing platform) according to an embodiment; and

FIG. 4 is a schematic diagram of the technical architecture of a digital asset trading system according to an embodiment.

### DESCRIPTION OF THE INVENTION

For a better understanding of the objects, technical solutions and advantages of the embodiments of the present application, the technical solutions of the embodiments will be described clearly and fully with reference to the accompanying drawings of the embodiments. As a matter of course, the embodiments described herein are merely some examples of the present application; any other embodiment obtained by those skilled in the art based on the embodiments herein without inventive effort shall fall within the scope of protection of the present application.

In the detailed description below, references are made to the accompanying drawings, which are part of the application for illustrating particular embodiments of the application. In the accompanying drawings, similar symbols may denote substantially similar components in different drawings. The particular embodiments of the present application are described in sufficient detail below to enable those skilled in the art to implement the technical solutions of the present application. It is understood that other embodiments, or structural, logical or electrical changes to the embodiments of the present application, may also be used.

As would be known by the person of skill in the art, a blockchain is a digitized distributed ledger operating on distributed computing apparatus using a peer to peer network, in which entries/transactions are secured by cryptographic signatures, such that the historical record of transactions cannot be tampered with and leave a verifiable audit trail. The blockchain is formed of blocks, each of which hold batches of transaction (smart contracts) with each block including cryptographic hash of the previous block in the chain to form a chain of blocks. Each block contains batches of valid transactions, each of which can be independently verified and audited. The blockchain is collectively managed by the peer-to-peer network using a predefined protocol for validating new blocks. Once a transaction or data is recorded in a block, the data (or block) cannot be altered retroactively, without the alteration of all subsequent blocks, and would require a majority of the distributed network to agree to the change. Blockchains are thus considered secure by design and may be considered an example of a distributed computing system with high Byzantine fault tolerance. Blockchains may be public, in which anyone can send (or write) transactions to the blockchain, or act as a validator, or the blockchain may be private blockchain, often known as a distributed ledger, in which only authorised users or entities can send/write transactions or validate blocks. We will use the term blockchain to cover both public and private blockchains, and distributed ledgers. Many different blockchain (and distributed ledger) technologies exist such as Bitcoin and Ethereum. In some embodiments, generation and issuance can be done, for example, through the Ethereum public blockchain. Ethereum is an efficient distributed virtual machine that allows end users to construct smart contracts for transactions. The smart contracts are stateful applications or software code stored on the Ethereum public blockchain. These contracts are secured with encryption algorithms, for verifying or enforcing the contracts. When a smart contract is deployed on a virtual machine and the trigger condition is satisfied, the smart contract will be automatically executed and published on the blockchain, providing a reliable and trusted mechanism for representation of an asset. Further smart contracts running on blockchains such as the Ethereum public blockchain are traceable, tamper-proof and are decentralized. Further they have the important characteristic of being permanently recorded on the blockchain.

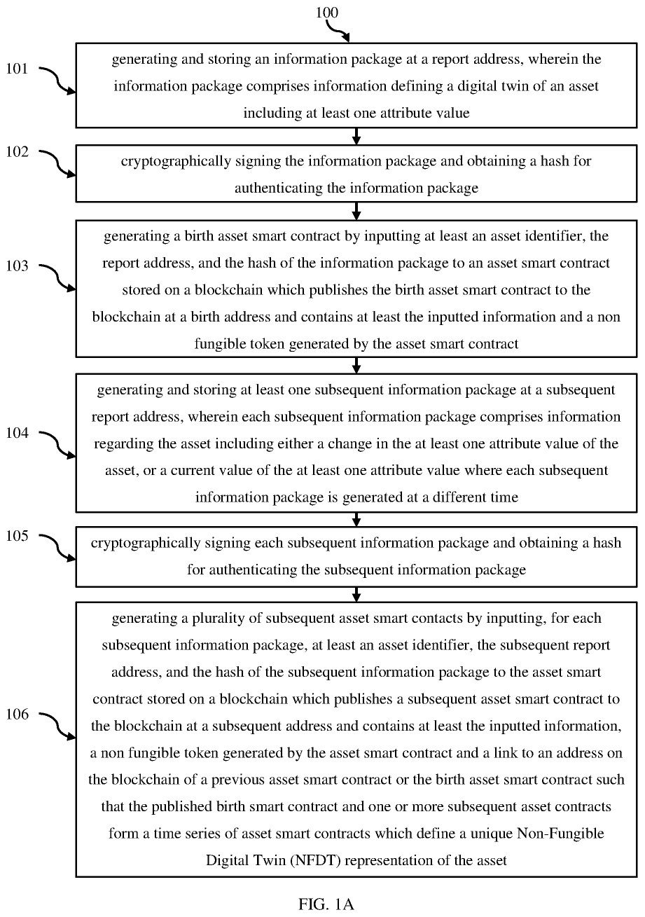

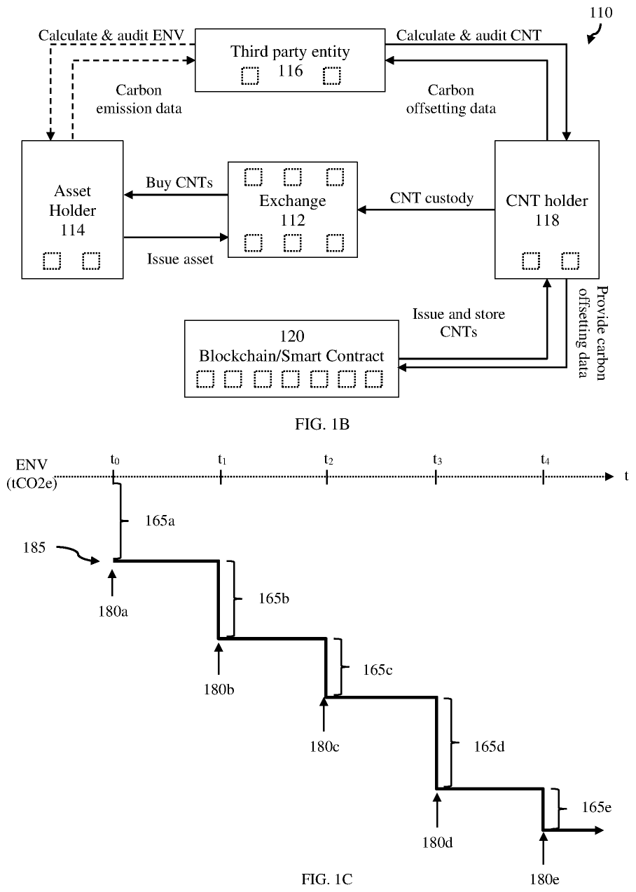

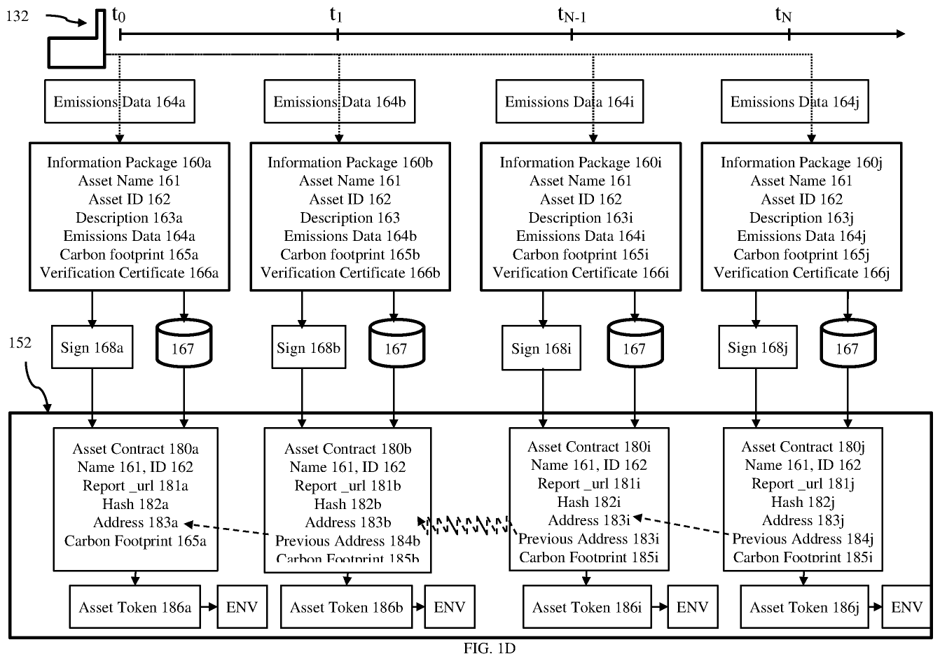

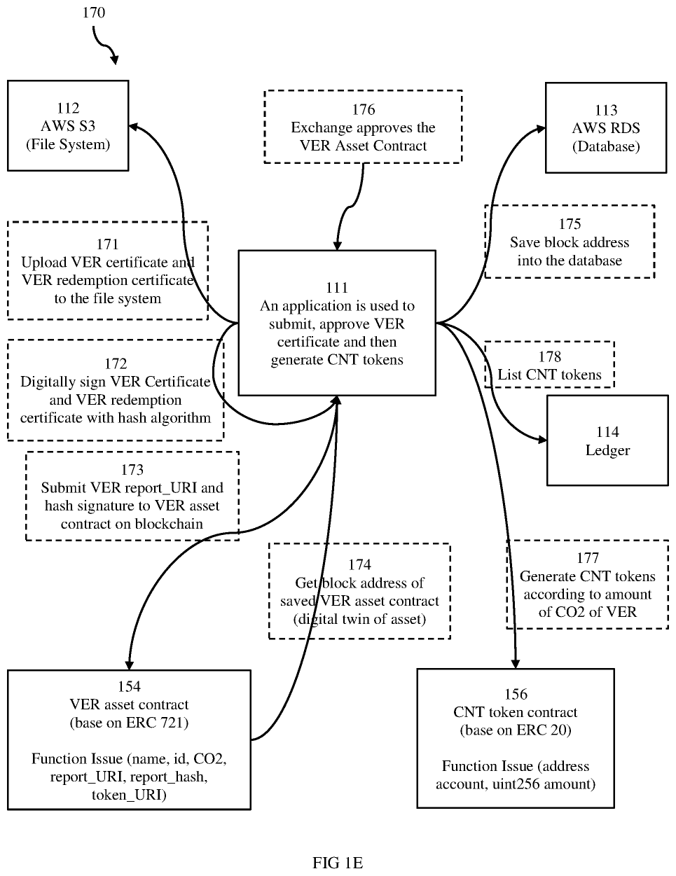

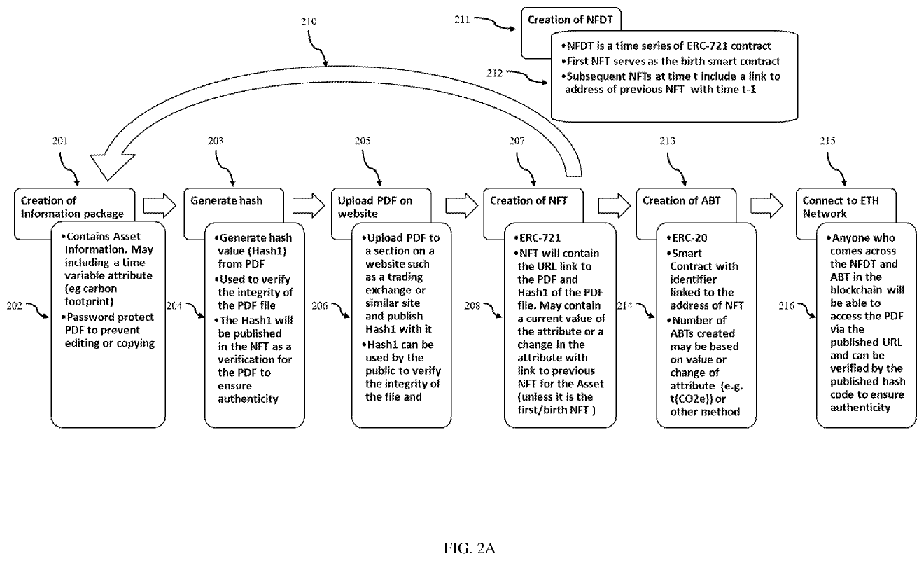

With reference to FIG. 1A there is shown a flowchart of a method 100 for generating a dynamic Non-Fungible Digital Twin (NFDT) representation of an asset according to an embodiment. Embodiments of the method may be used for creating dynamic digital representations, or living digital twins of assets, including both real world and virtual assets. The digital twin of the asset includes at least one attribute value. Attribute values are to be interpreted broadly and the NFDT track changes in the asset through tracking changes in the attribute value over time. The attribute value may be some property, characteristic or parameter of the asset, or it may be associated with the asset, such as an operational or financial outputs, or some other observable or measurable change. For example the asset may be a wind farm or manufacturing plant, and the attribute value could be its legal ownership, its operational KPIs, its financial performances, its carbon neutrality status or carbon footprint which will change over time. In the case of a building the attribute could be the title of the building, the electricity consumption, the number of visitors (or occupants), and the financial performance at any point in time. In the case of a media asset such as digital weekly column, the attribute could be the content (which is updated weekly) or some other measure of the change in content (eg size or a hash of the content). The digital twin of the asset may be a coarse representation of the asset containing only one tracked attribute and minimal identifying information, or it be a detailed representation in which many attributes are tracked and significant information documented regarding the asset. In addition, various organizations, parties or entities across the lifecycle of the asset may be responsible for, and/or have an option, to add additional smart contract nodes with information packages to the NFDT. For example in the case of NFDT for an electric vehicle battery, the first step should be the battery manufacturer who should write the birth smart contract incorporating the raw materials, manufacturing parameters and other industrial 4.0 information into the NFDT. Once the battery is sold to a car company, it should be the car company to write follow on smart contract nodes on how the battery pack is put into the car and its relationship with other components of the car. Then after the car is sold to individual consumers, more operational data will be written to the NFDT. Every step of the process, any change of title (or responsibility) may be captured along with the attribute of interest (e.g. carbon footprint etc). If the NFDT is used as the underlying assets for financing activities, more financial related information will also need to be written by firms such as auditing firms and legal firms. In this manner, the NFDT is an open platform for related information to be stored throughout its full life cycle.

One additional feature of an NFDT is that it can be made of other NFDTs to form larger and more complex records or collections. For example an NFDT of an asset may be a collection of NFDTs (that is it may contain NFDTs), such as NFDT of components or properties of the asset. The collection may be a hierarchical collection in which those components also contain their own collections of NFDTs. For the example of Electric Vehicle (EV) batteries, an NFDT of battery cells together with and NFDT of a battery management system form the NFDT of the battery pack. Then NFDT-battery pack and other components form the NFDT of electric vehicles. Then a fleet of NFDT electric vehicles may form the NFDT of a car rental company.

Embodiments of the methods create NDFTs which are living/dynamic digital twins of the respective asset. For example an owner of a wind farm (the asset) may wish to track the carbon footprint (the attribute) and in particular carbon reductions/offsets generated by the wind farm. Similarly a battery manufacturer may wish to track the carbon footprint (attribute) of the production process (asset) so any emissions can be offset. In another instance a building owner may wish to track the number of persons (attribute) that enter the building (the asset), for example to enable the setting of a price for advertising space in the foyer of the building. In another embodiment an airline may wish to record the number of hours flown by each aircraft for compliance with maintenance requirements. In the case of dynamic media content or media assets, such as a weekly column, a website which is periodically updated, or a video series, a NFDT and ABTs may be generated to monetise the digital content or media asset, or for tracking consumption of the assets by consumers. Further with the growth of the metaverse, which is a designed to be an immersive digital world or environment, there is interest in creating digital representations, or digital twins, of real world objects in the metaverse. In some embodiments NFDTs may be used as the digital twin of a real world objection in a Metaverse. Note that being digital environments, there may be multiple metaverses created and thus we will call a specific instance as a Metaverse.

At step 101 we generate and store an information package at a report address. The information package comprises information defining a digital twin of an asset including at least one attribute value. In many embodiments many attribute values may be recorded. The report address may be a Uniform Resource Identifier (URI) address or a Uniform Resource Locator (URL) address. The attribute may be a tradeable characteristic of the asset. In some embodiments the information package is generated automatically by a monitoring system, such as a monitoring system using automated sensors and/or Internet of Things (IoT) devices configured to monitor and output an attribute of the real world asset. In some embodiments the monitoring systems may monitor computational systems or electronic document storage devices for lodgement or storing of new electronic documents related to the asset. At step 102 we cryptographically sign the information package and obtain a hash for authenticating the information package. At step 103 we generate a birth asset smart contract by inputting at least an asset identifier, the report address, and the hash of the information package to an asset smart contract stored on a blockchain which publishes the birth asset smart contract to the blockchain at a birth address and contains at least the inputted information and a non fungible token generated by the asset smart contract. Then at least one attribute value may also be input. This input triggers execution of the asset smart contract and publishing of the birth asset smart contract to the blockchain at the birth address. This contains at least the inputted information and a non fungible token generated by the asset smart contract. In some embodiment the information package may include an identifier of an owner of the asset, such as a name, ID, URL/URI, address, etc. One or more of the attribute values may include an attribute value related to a title or other proof of ownership by the owner. The identifier of the owner may be provided as an input to the asset smart contract. These steps thus create an initial or birth smart contract of the asset at an initial time point.

Over time the asset may change. For example if the asset was a wind farm and the attribute value was carbon emissions then this will change as energy is generated. Similarly if the asset is a media asset and the attribute value was content, then this would change as new content is added. Thus to track these changes to the asset the method further comprises the step 104 of generating and storing at least one subsequent information package at a subsequent report address. Each subsequent information package comprises information regarding the asset including either a change in the at least one attribute value of the asset, or a current value of the at least one attribute value. Each subsequent information package is generated at a different time. The subsequent information packages may be generated automatically by a monitoring system, including sensor based, IoT based, and/or electronic document monitoring systems. At step 105 we cryptographically sign each subsequent information package and obtaining a hash for authenticating the subsequent information package and at step 106 we generate a plurality of subsequent asset smart contracts by inputting the asset identifier, the subsequent report address, and the hash of the subsequent information package to the asset smart contract stored on a blockchain. This triggers execution and publishing of a subsequent asset smart contract to the blockchain at a subsequent address. This contains at least the inputted information, a non fungible token generated by the asset smart contract and a link to an address on the blockchain of a previous asset smart contract or the birth asset smart contract. In some embodiments the change in the attribute value(s) or the current value of the attribute value(s) may also be input. The published birth smart contract and one or more subsequent asset contracts form a time series of asset smart contracts which define a unique Non-Fungible Digital Twin (NFDT) representation of the asset. That is a time series of linked NFTs where each NFT or smart contract is a node of the NFDT. Thus steps 101 to 103 are performed to create the birth smart contract and steps 104 to 106 are performed repeatedly at a plurality of different times (creating a series of nodes on the blockchain).

The subsequent asset contracts are linked to create a time series, and thus a live record or live/dynamic digital twin of the asset. The linking could be done in several ways. This may be linked to the address of the previous asset contract, or each subsequent contract could link back to the address of the birth contract. Traversal methods can be provided in the smart contract code to allow any all contracts to be located and visited. These may utilise a link back to the birth contract and time stamps on when subsequent asset contracts are published. Thus a subsequent asset contract may be linked to the previous asset contract (or any asset contract) indirectly via the birth asset contract and time stamps. A subsequent asset contract may link back to multiple previous asset contracts, such as the last n previous contracts, or the previous contract and the birth contract, or every nth previous contract. Methods for obtaining all asset contracts or specific asset contracts within the NFDT for example based on time or index numbers, may also be provided as part of code of the smart contract on the block chain. In the description that follows we will occasionally refer to each subsequent asset contract as a node of the NFDT. As each smart contract is written to a block of the blockchain, a node of the NFDT will effectively correspond to a node or block of the blockchain.

The use of stored information packages which are cryptographically signed enables the amount of content written to the blockchain to be minimised, and thus allows the digital twin of the asset to be a coarse representation containing only one tracked attribute and minimal identifying information, or it be a detailed representation in which many attributes are tracked and significant information documented. In some embodiments the at least one attribute value is stored in the information package so that it does not need to be explicitly input or included in the published asset contract but can be indirectly obtained from the link to the information package. Alternatively the at least one attribute value may be provided as input to the asset contract or included in the published asset contract so that the value is easily accessible and available on the blockchain. In this embodiment the at least one attribute value could be omitted from the information package as it is provided in published smart contract together with the link to the information package. Further subsequent information packages may only contain updates to information in an earlier information package, and thus represent a summary of changes to the asset e.g. the subsequent asset contracts form a change log for the asset. As outlined above, the subsequent information packages may be automatically generated by appropriately configured monitoring systems. For example the monitoring system may execute software that is configured to take measurements at specific times for an attribute of interest (to obtain the attribute value) or to watch for specific events which triggers generation of another smart contract node. The software may be configured to specify conditions under which information packages are to be generated (and signed), and used to trigger generation of an additional smart contract (node) of the NFDT.

In some embodiments automated monitoring of the asset is performed to detect a change in at least one of the at least one attribute value and either periodically or on detection of a threshold change, publishing a subsequent information package containing the change in the at least one attribute value or the current value of the attribute value which triggers publishing of a subsequent asset smart contract based on the update to the attribute value.

In some embodiments the attribute is a tradeable characteristic of the asset and thus publishing of the subsequent asset contracts is used to trigger the generation of a plurality of Asset Backed Tokens (ABTs). This occurs by executing an ABT smart contract stored on the blockchain. The amount of ABTs issued is determined from the change in the at least one attribute value in the asset smart contract or each ABT issued represents a fractional ownership of the NFDT and the underlying asset and the ABT smart contract contains a link to the respective asset smart contracts. The ABTs are then stored and may be offered for trading on a trading exchange. The trading system may implement a ledger and cold wallet and be configured to store the ABTs and facilitate trading of the ABTs between multiple parties.

In some embodiments the attribute value is a carbon footprint of the asset and represents carbon emissions and/or carbon reductions measured in tonnes of CO2 equivalent (tCO2c), and the ABT is a carbon neutrality token (CNT). The CNT is that a digital depository receipt of one tonne of verified and registered carbon voluntary emission reductions. This may then allow trading of the CNTs to offset carbon emissions or to monetise emission reductions. Thus in one embodiment the information packages contains information regarding a carbon offsetting action in a first country, a carbon emission reduction certificate from an issuing authority in a first country in relation to the carbon offsetting action which generated an amount of verified carbon emission reductions, and a redemption certificate which prevents further trading of the carbon emission reduction certificate in an issuing country where the issuing country may be the first country or a different country. That is the owner can choose whether the carbon reduction has transferability or not.

For example consider the case where Company A in Country X planted a carbon absorbing forest, and then certified and registered resulting emissions reduction in its account. When Company A plans to sell the carbon credits to Company B in Country Y so that Company B can use it to offset its pollutions Company A can choose whether such transferred carbon credit unit contains national transferability or not in addition to commercial/environmental interests transferability. If it is nationally transferable Company B can use the purchased carbon credit to offset its own pollution and at the same time help Country Y in its national carbon reporting. As this carbon credit is already transferred out of Country X, Country X cannot use it to count for its national carbon reporting anymore. If the carbon credit is not nationally transferable, it essentially becomes a digital depository receipt (similar to American Depository Receipt) of such carbon credit and can be used by Company B for voluntary carbon neutrality efforts, while still counted as a carbon reduction by Country X in their national carbon reporting. Company B still can achieve net zero effect from global perspective as its pollution is indeed reliably offset by carbon offset somewhere in the world, although Company B's purchase cannot count toward Country Y's national carbon contributions.

In some embodiments, for example in the case of digital asset, we generate a plurality of Asset Backed Tokens (ABTs) by executing a ABT smart contract stored on the blockchain, wherein the ABT contains a link to the respective asset smart contract, and one or more of the plurality of ABTs are offered for trading on a trading exchange. The number of ABTs issued may be determined according to a predefined process, for example based on a book building exercise or a property of the asset, and may be used to monetise the asset. The ABTs may be used to represent fractional ownership of the NFDT and the underlying asset. Each ABT may store the respective fractional ownership of the ABTs and the sum of the fractional ownerships of all the ABTs issued may sum to 1. For example the number of ABTs to be issued may be based on the number of shares of ownership to be issued, and store the fractional ownership that each ABT represents. This could be a 1:1 relationship such that if there are N shares then there are N ABTs where each ABT is 1/N fractional ownership. Alternatively the ABT may store the fractional ownership. That is if there are N total shares where N=M+O+P, a first ABT may represent M/N shares (and this value may recorded in the ABT), a second ABT may represent O/N shares (and this value may recorded in the ABT), and a third ABT may represent P/N shares (and this value may recorded in the ABT).

In some embodiments, NFDTs may be used to represent a digital twin of an asset in a Metaverse comprising a digital representation of a plurality of real world objects. In addition to creating digital twins of real world objects, NFDTs may be used to recording attributes of dynamic virtual assets including virtual assets native to the metaverse.

The method may be implemented by a computational system including one or more processors, one or more memories, one or more storage devices, and one or more interfaces configured to implement the method. The computational system may include the blockchain, such as a private blockchain, or communicate with a public or external blockchain (also known as a distributed ledger). The computational system may include a monitoring system configured to automatically generate information packages and generation of additional nodes.

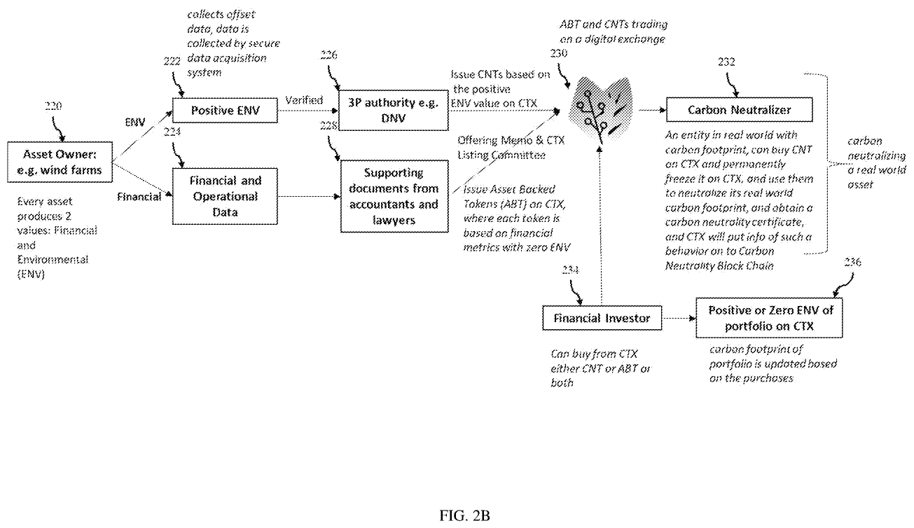

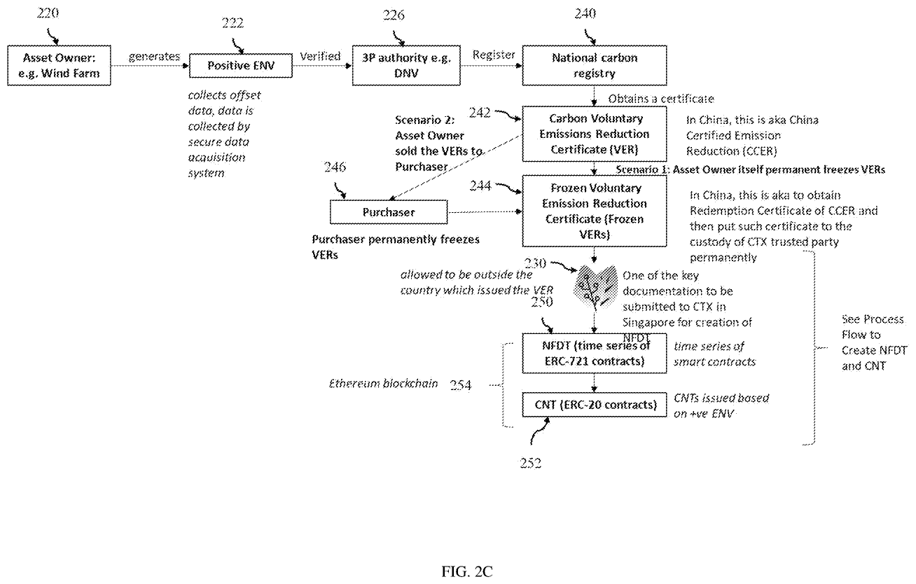

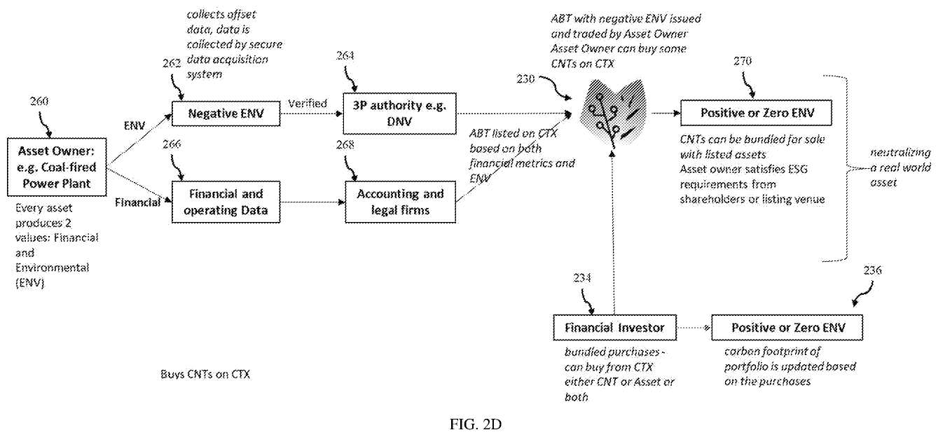

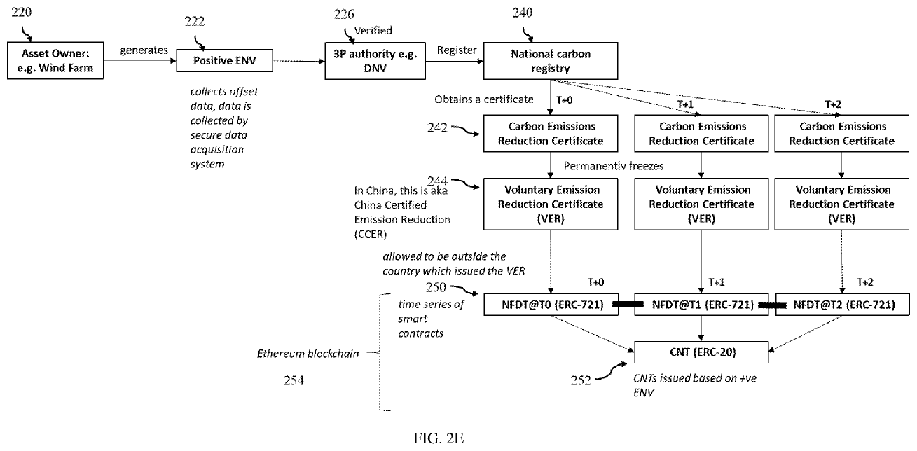

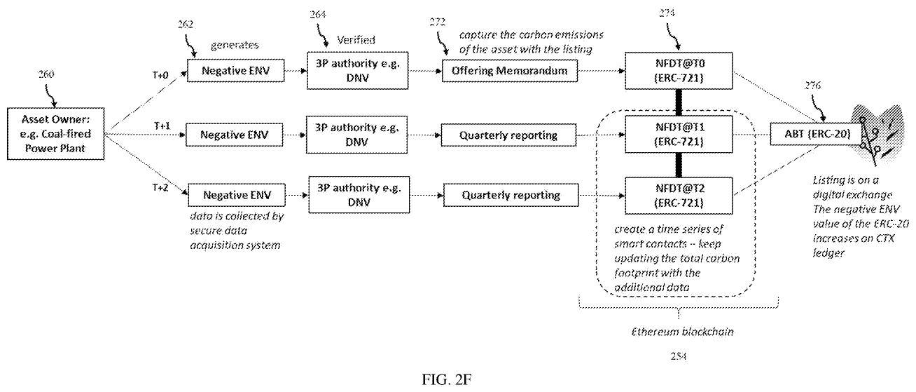

In one form, the blockchain is an Ethereum blockchain, and the asset smart contract is based on the ERC721 standard. The ABT smart contract may be based on the ERC-20 standard and the ABTs may be fungible tokens. This is further illustrated in FIG. 2A which is a schematic flowchart of a method for creating an NFDT and ABTs on an Ethereum blockchain according to an embodiment. An information package, for example an offering memorandum in the case of carbon offsets, is created as a PDF 201. The information package contains asset information and may include a time variable attribute such as an electronic carbon footprint (ENV) value (discussed below) or some other attribute (e.g. content, or size of content). Other information may be included for example a carbon emission reduction certificate and a redemption certificate. The information package creates a digital twin of the asset and can as much (or as little) information as is desired. The PDF may be password protected to prevent editing or copying. The password can be randomly generated, and kept or discarded if no intention of ever editing the file. A hash is generated 203 (hash1) from the PDF. This is used to verify the integrity of the PDF file. The Hash1 will be published in public Ethereum chain as a verification for the PDF in the NFDT and smart contract to ensure authenticity. The PDF is then uploaded to a website 205. In one embodiment the PDF is uploaded to a section in an exchange (e.g. CTX.sg) and we publish the Hash1 in the NFDT in public Ethereum. Hash1 can be used by the public to verify the integrity of the file. We then create an NFT 207. This is based on ERC 721 (NFT standard) such as illustrated in the example shown in Table 4 below which contains portions of a specific ERC-721 based smart contract for tracking carbon footprint of an asset. The steps 201 through 208 may be repeated 210 to create an NFDT 211 which is a time series of ERC-721 smart contract. The first ERC-721 will contain the URL link to the PDF and Hash1 of the PDF file. This serves as the birth smart contract of the NFDT. Subsequent NFTs at time t include a link to address of previous NFT with time t-1, thus creating the linked time series and NFDT representation of the asset. The change in the attribute may also be stored in the NFTs forming the NFDT. We may then optionally create Asset Backed Tokens (ABTs) 213. This is based on an ERC-20 smart contract. The Smart Contract with identifier linked to the address of the birth ERC-721 contract of the NFDT will contain the URL link the same as that of NFDT it is pointing to. The amount of ABTs may be based on the value of the attribute or change in the value of the attribute, or according to some other method (e.g. book building). ABTs may be generated from the birth asset contract or from subsequent asset contracts. We then connect to the Ethereum network 211. Anyone who comes across the NFDT and ABT (or CNT in this example) in the blockchain will be able to access the PDF via the published URL. The PDF file will be verified by the published hash code to ensure authenticity.

As outlined above, multiple parties may be allowed to write new smart contracts (or new nodes) to the NFDT of the asset to record relevant activities over the life cycle of the asset. For example in the battery case discussed above, the battery manufacturer, component suppliers, car company, and the consumer may all wish to write additional smart contracts to record relevant events or changes through the battery life cycle. In some embodiments the NFDT may use permission control mechanisms to control who is allowed to write new smart contracts (new nodes) to an NFDT. For example the birth contract of the NFDT could record a list of authorised parties (or entities) that are allowed to submit data and execute smart contracts (e.g. to add a node) to the NFDT. The allowed activities could also be recorded, such as ability to add or remove an authorised party, or control what type of information may be submitted. In one embodiment the smart contract could require the data submission include an identifier of the submitter, and the smart contract is written such that it will only be executed if the identifier is in the set (or list) of authorised parties. Further the list of authorised entities could be updated over time. For example in the above battery case, when the battery is sold to the car company, the battery manufacturer could be removed from the list of authorised entities and the car company added. The car company could authorize additional third parties to write new contracts, for example suppliers such as a power company or other advisors or certification authorities. In some embodiments the blockchain is a private blockchain which provides mechanisms for controlling access rights including the rights to send/write contracts.

To further illustrate the NFDT concept, various embodiments will now be discussed in more detail with reference to the figures to further illustrate the various methods and systems. In one embodiment an NFDT is used to track the carbon footprint of an asset. The asset may be wind farm which in addition to an initial carbon footprint associated with construction of the wind farm, generates carbon reductions over time. In another embodiment the asset may be a manufacturing plant, for manufacturing batteries which consumes resources and generates carbon emissions as the batteries are manufactured, which the owners may wish to offset. In another embodiment the asset may be a virtual asset as a video or bitcoin in which energy is used to generate the virtual asset and energy is used each time the video is viewed or the bitcoin is used. Embodiments of the system may be used to track the energy used and thus the NFDT may then be used to track the carbon footprint of the asset. In another embodiment the system may be used to monetise physical or media assets. For example the asset may be a building and the NFDT may track the number of visitors or occupants for advertising purposes. In another embodiment the asset is a media asset such as a weekly column. The NFDT may be used to track content on the website (which is added each week) and ABTs offered to investors who share profits from the website.

Turning now to FIG. 1B there is shown a structural diagram of an asset trading system according to an embodiment. In this embodiment we use an NFDT to track the carbon footprint of an asset such as a wind farm by define a carbon footprint attribute value (ENV) of the asset. The calculation of carbon footprint can be pursuit of international standard such as ISO14064 for operation and ISO14067 for product and can also be certified by a reputable third party. This is calculated or monitored, and changes stored in the NFDT. In this embodiment changes are then used to generate ABTs which in this embodiment will be referred to as Carbon Neutrality Tokens (CNTs) which may then be traded on the trading exchange. The ENV value may be calculated as the difference between a baseline scenario determined according to the normalized carbon emission data of the asset (or asset category), E_{Baseline}, and the actual emission data of the asset, E_{Actual}, such that ENV=E_{Baseline}−E_{Actual}, and is measured in tonnes of CO2 equivalent emission (tCO2e). A 1:1 mapping of CNT to 1 tonne of CO2 equivalent emission may be used (1 CNT=1 tCO2e).

Embodiments of the method may be implemented in a national carbon registry, a multi-jurisdictional carbon registry or in a trading platform which enable the creation of cross-border carbon credit trading mechanisms without triggering National Determined Contribution (“NDC”) constraints and without dependence on Article 6 of Paris Agreement solutions and which thus solve the issues of transferability. One of the significant challenges facing the current global carbon trading markets is that they are highly fragmented and lack of an effective cross-border trading mechanism to form a global carbon trading system. In particular, each country has a National Determined Contribution (“NDC”) that specifies the contribution of carbon emission reduction by each country, and hence unfortunately created a “sovereign ownership” issue of any carbon emission reduction efforts (including voluntary emission reductions) as the each specific country tries to meet its own NDC target. This makes the free transfer of carbon emission reduction credit across borders impractical, which is ironic given carbon should be a global matter and dealt with on a global basis. Article 6 of Paris Agreement is designed to address this issue and to create a cross-border and global trading system for carbon emission reduction credits. However, to this date, Article 6 of Paris Agreement remains under negotiation and hence various stakeholders globally are in holding patterns waiting for further negotiations and, hopefully, eventual finalization of Article 6 of Paris Agreement. This thus creates issues associated with separation of participants, and the lack of a firmly established linkage mechanism across countries and global regions. As outlined above, carbon allowances are issued on a national or regional basis, and their allocation and compliance are based on the carbon emissions produced by emission control companies, with no consideration of carbon emissions that are transferred outside the borders through products or services (transferred carbon emissions).

Embodiments of the methods described herein (and in particular the process of creating NFDT for an offsetting asset or project) provides methods for creating cross-border carbon credit trading mechanism without triggering NDC constraints and without dependence on Article 6 of Paris Agreement. In particular they allow the country in which emission reductions are occurring to record the reductions in their registries and to contribute to their NDC, and to freeze this reduction whilst allowing a digital representation of the asset or project to be created which can be freely traded across borders (whether by the original owner/offset or another party). Emission reductions may also be permanently frozen and used to neutralize the carbon footprint of real world assets. Embodiments of the method and systems described herein further enable creation of carbon registries and trading platforms (implementing NFDTs) enable the creation of cross-border carbon credit trading mechanisms without triggering National Determined Contribution (“NDC”) constraints and without dependence on Article 6 of Paris Agreement solutions and thus solve the issues of transferability.

As shown in the FIG. 1B, an asset trading system 110 includes: an exchange 112, a CNT holder 118, an asset holder 114, and a third party entity 116. The asset holders and CNT holders may be the owners of the assets that generate emissions or emission reductions, or they may be a person who purchasers the emissions or emission reduction certificates in the country where the emission or emission reduction activity occurred. Traders (or investors) may use the asset trading system to make trades to purchase listings and/or CNT to build a portfolio. The asset holder 114 lists assets and the carbon footprint attribute (ENV) of each asset is determined and verified by the third party entity, and the carbon footprint attribute (ENV) is bound to the digital representation of the asset on the exchange. This captures the carbon footprint (e.g. carbon emissions) in creating the physical asset, or which is created by the physical asset over time (e.g. a power station). Investors or the asset holder may buy CNTs of the CNT holder 118 through the exchange 112, to increase its total carbon footprint attribute (ENV) value, for example to achieve carbon neutrality for the asset. An asset holder may also use CNTs to offset their carbon footprint of their other assets. Asset holder may work with a CNT holder on the exchange to offer bundled trades. The exchange also allows an investor or asset holder to determine their the total carbon footprint by summing the carbon footprint attribute value of each listing/NFDT, and any offsetting CNTs held to provide a mechanism to easily and clearly meet Environmental Social and Governance (ESG) reporting requirements. Computing apparatus for implementing functionality of the various components of the system 110 (e.g. blockchain, calculation) are represented by dashed rectangles.

The exchange 112 could be a distributed system on public and private blockchains or other computing apparatus (e.g. distributed servers) or it may be formal registered asset trading exchange which is regulated and performs additional trading, listing and verification services. The exchange 112 may be a trade matchmaking system and trade monitoring system serving a variety of compliant exchanges in various countries and regions worldwide. It ensures powerful and efficient trade matching to handle the requirements, and also provides real-time monitoring for violation transactions to effectively protect the legitimate rights and interests of investors.

In some embodiments, assets that are traded in the exchange 112 may include, for example, various digital tokens based on physical assets, such as stocks; digital currencies (e.g., BTC/ETH); or alternative real assets (e.g., artwork, diamonds), as well as assets such as non-renewable power plants, vehicles, or equipment or which generate carbon emissions during use or over time (whether directly, or indirectly such as through consumption of power).

According to an embodiment, from the perspective of energy conservation and emission reduction, the CNT holder 118 may be a green company, such as a new energy technology research and development and provision company (photovoltaic, wind energy or hydroelectric company), or a afforestation company, which can obtain double benefits in both financial rewards on its own products and CNT in return. According to other embodiments, the CNT holder 118 can also be an ordinary company, due to its energy conservation and emission reduction action, either for production or for living (green office, green transportation, etc.), can be rewarded with CNTs according to CNT rules, so long as an authoritative third party proves that its actual carbon emissions from the production or living processes are lower than a benchmark, so that emission reduction actions can be financially rewarded.

According to another embodiment, from the perspective of industrial nature, the CNT holder 118 may be an information technology company, such as a platform for digital payment, bicycle sharing, car sharing, distributed renewable energy management, etc., which itself has the ability to organize and aggregate the green consumptions of consumers and provide key information to quantify the carbon offsetting contribution of these actions in the form of big data; once verified by a third party, can also be rewarded with CNTs accordingly.

Furthermore, the CNT holder 118 may also be an ordinary consumer, or an environmental protector. Through corporate organizations, ordinary consumers and environmental protectors can participate in the CNT system as well. Through their green consumption actions, ordinary consumers and environmental protectors not only contribute to the carbon neutrality ecological cause, but also receive CNTs while receiving corresponding rewards and returns by trading CNTs in the exchange.

A CNT holder 118 may also be an investor or entity who purchases the CNT from the above parties (or intermediate parties). Thus a CNT holder may be an entity that performs a carbon offsetting action or may be an entity who obtains emission reduction certificates from a previous owner (and ultimately the original entity that performed the carbon offsetting action).

The exchange 112 allows an asset holder to list assets on the exchange. However, to facilitate disclosure of the carbon neutrality status of an asset holder, the exchange 112 requires that the asset holder 114 provide the verified carbon footprint attribute (ENV) of an asset to be included in the listing documentation on the exchange 112. In one embodiment this includes creating a NFDT which is a digital representation of the asset on the exchange through the use of a time series of linked smart contract generated according to the method illustrated in FIG. 1A. Each asset smart contract includes an amount of carbon emissions (or a carbon footprint) generated since the previous smart contract (or in the case of the birth contract, the emissions in creating the asset) and thus the carbon footprint attribute (ENV) is bound to the representation of the asset. The carbon footprint attribute (ENV) is stored in a ledger of the exchange. This digital (NFDT) representation will mirror ENV realism of the asset by tracking changes in the ENV value, such as generation of additional carbon emissions over time, or the purchase or sale of CNTs, all of which will alter the carbon footprint attribute (ENV) of the asset.

FIG. 1C which is a plot of the carbon footprint attribute value (ENV, in units of tCO2e) over time (curve 185) of an asset, which is maintained in a ledger of the exchange. At time to, the carbon footprint attribute (ENV) value of an asset is the carbon footprint value 165a as included in Asset Contract 180a. Then at time t₁, Asset Contract 180b is executed listing additional emissions 165b leading to a decrease in the carbon footprint attribute (ENV) value of the asset (by amount carbon footprint value 165b). Then at time t₂, Asset Contract 180c is executed listing additional emissions 165c leading to a further decrease in the carbon footprint attribute (ENV) value of the asset (by amount carbon footprint value 165c). As further illustrated in FIG. 1C, at additional time points t₃ and t₄, additional emissions are reported and ENV progressively decreases by further amounts carbon footprint value 165d and carbon footprint value 165c.

This is further illustrated in FIG. 1D which is a schematic diagram representing a linked chain of smart contracts used to digitally represent the change in carbon footprint attribute (ENV) of an asset over time according to an embodiment. At time to, the asset is listed on the exchange 110. This requires obtaining carbon emissions data 164a to determine the carbon footprint of the asset. This may be the sum of all carbon emissions measured in tonnes of CO2 equivalent (tCO2c) involved in the manufacture or production of the asset. An information package 160a is generated which in one embodiment comprises an asset name 161, and asset ID 162, a description 163a, the emissions data 164a, the carbon footprint 165a which is estimated from the emissions data 164a, and a verification certificate 166a generated by the third party entity 140 who performed the calculation of the carbon footprint 165a, or verified the calculation was performed correctly. The description may comprise a description of the asset and how it was manufactured, and any other relevant data such as how the calculation of the carbon footprint 165a was performed. The carbon footprint 165a may be provided as a value in units of tonnes of CO2 equivalent (tCO2c). The information package 160a may then be stored as a PDF report, or similar electronic container file in a database 167 with an associated report address which is a unique access location such as a Uniform Resource Identifier address or Uniform Resource Locator address. In this embodiment the address is a URL (report URL 181a) but it will be understood that this may be a URI address. This storage address may be on a storage device (e.g. in a webserver) of the digital trading exchange 110 and may be accessed by an associated webserver of the digital trading exchange or other digital interface provided by computing apparatus of the digital trading exchange 110. However it could also be on a storage device on another server, or in a cloud storage device. The information package is submitted to the exchange which checks and then cryptographically signs the information package to generate a unique hash 182a for the information package, and which can be used to verify the authenticity of the information package at the access location (report_URL 181a). Thus when the report_URL (or URI) is accessed the hash may also be provided, and the document is only served if the hash authenticates the information package (and thus verifies it has not been modified). A warning may be issued if the authentication fails which may indicate that the report may have been altered. The asset name 161, asset ID 162, description 163a, report_URL 181a, hash 182a, and the carbon footprint 165a are provided as input to a smart Asset Contract 180a which is executed on a blockchain which generates an asset token 186a which can be used to represent the asset. The address 183b represents a storage address (e.g. block on the blockchain) where the Asset Contract 180a is stored. The token 186a acts as a birth certificate for the asset and the address 183b then indicates the location where the birth certificate is stored on the blockchain (and may thus be viewed). The token 186a may then be stored in a database by exchange 110 and used to access the published smart contract or information contained in the published smart contract. The initial carbon footprint attribute (ENV) value is the carbon footprint 165a and this ENV value is stored in the ledger (and thus the initial ENV value will be the initial carbon footprint 165a.

Rather than being a single record or snapshot, the digital representation (NFDT) of the asset is a live (or continuous) representation of the asset over time and thus is designed to capture changes in the carbon footprint attribute (ENV) value over time. For example, in this embodiment the physical asset continuously generates carbon emissions which are reported at regular intervals such as every quarter. Thus, at time t₁, additional emissions data 164b of the asset 132 over the time period (t₁-t₀) are collected and stored. A second information package 160b is prepared. This information package 160b is generated comprising an asset name 161, and asset ID 162, a description 163b, the emissions data 164b, the carbon footprint 165b which is estimated from the emissions data 164b, and a verification certificate 166b generated by the third party entity 140 who performed the calculation of the carbon footprint 165b, or verified the calculation was performed correctly. The description may comprise a description of the asset, the timer period or time stamp t₁ and any other relevant data such as how the calculation of the carbon footprint 165b was performed. The information package 160b may then be stored as a PDF report, or similar electronic container file in the database 167 with an associated unique access location (report URL 181b), and then submitted to the exchange for checking, who then digitally sign 168b to generate a hash 182b. The asset name 161, asset ID 162, description 163b, report URL 181b, hash 182b, an address 183b and the carbon footprint 165b are provided as inputs to a smart Asset Contract 180a, along with the address of the previous Asset Contract which in this case is the birth address (that is previous address 184b=birth address 183a). This address could be provided as token 186a. This generates another asset token 186b which may be stored by the exchange 110. The carbon footprint attribute (ENV) value of the asset (ENV) is then updated on the ledger to include the additional emissions (e.g. ENV=carbon footprint 165a+ carbon footprint 165b).

This creation and submission of information packages 160 to execute additional Asset contracts 180 for the asset is repeated over time, where each subsequent Asset Contract is linked, and the carbon footprint attribute (ENV) value associated is updated after each contract (based on the carbon footprint 165 in the asset contract). FIG. 1D showing information packages 160i and 160j at times t_{N-1} and ty respectively along with asset contracts 180i and 180j. As noted previously asset contract 180j at time ty includes a reference to the address of the previous asset contract 180j generated at time t_{N-1}. In this way a linked list of Asset Contracts is generated for an asset, all of which are (immutably) stored on the blockchain 152.

The method is further illustrated in FIG. 1E which is a schematic diagram of a method for generating emission reduction smart contracts and carbon neutrality tokens (CNTs) in respect of an offsetting action to create a Non-Fungible Digital Twin (NFDT) representation of the offsetting action. Each smart contract in the time series of smart contracts forming the NFDT is uniquely identified by the contract address (on the blockchain) and tokenID (a uint256) which provides a mapping to the address. The NFDT comprises a birth asset contract which captures all details of the asset and its carbon footprint (ENV), and a time series of subsequent asset contract each of which stores subsequent emission data or change to the carbon footprint attribute value (ENV) due such as due to emission reduction activities or purchase of CNTs at the present time (t). That is, after the birth contract, each subsequent asset contract stores the new carbon footprint information at the present time (t) and along with the address of the previous smart contract (t-1). FIG. 1D illustrates the process for generating a birth contract and CNTs resulting from an emission offsetting action. A modified process may be used to generate the subsequent emission reduction smart contracts and CNTs associated with additional emission reduction activity at a later time.

The owner 120 of a real world project such as wind, solar or energy emission projects (or assets) prepares an information package containing carbon offsetting action related data of the project. The carbon emission related data comprises relevant documents (e.g. description of project, time frame) and/or data as captured by the data acquisition system and devices as described above system, and/or by sensors (including IoT sensors) and software. The information package may be submitted to an authoritative third party verification and certification firm 140 to calculate, or verify a calculation, of the emission reduction in appropriate units (e.g. ton of CO2 emissions). The information package is submitted to the national carbon registry of the country (or region) where the real world project is located, or to where it can be attributed to (for example if the project was not conducted on land within the country such as in the ocean). After review and approval by the national carbon registry, the owner of the real world project is issued a voluntary emission reduction (VER) certificate which can be traded. For example, in China, this is called China Certified Emission Reduction (CCER).

In some embodiments the generation of a CNT is conditional on the redemption (or retirement) of the underlying VER. Thus, in this embodiment the owners of the VER go through the retirement process of the VER to prevent it from being further traded. After being verified by the national registry, the CNT issuer shall receive a certificate of VER retirement from the national registry. In China, this is called “Certificate of Redemption of Certified Emission Reduction”. This ensures the National Determined Contribution (NDC) will not be affected as the VER will not leave the country. In another embodiment the owner of the VER may sell or transfer the VER to another party through a national carbon exchange, regional carbon exchange or bi-lateral transaction, until the VER is purchased by the CNT issuer's subsidiary or related parties in the country. Then the CNT issuer's subsidiary or related party in the country shall go through the retirement process of the VER so that the VER shall never be able to be traded anywhere. Again, this ensures the NDC will not be affected as the VER will not leave the country.

An application 111 executing on the exchange system hardware is used to submit, approve the VER certificate (and information package) and then generate the appropriate amount of CNT tokens. The application interface enables the owner to upload an information (or data) package such as a PDF report (or similar file) which meets the exchange listing rule requirements 811 which is then stored on a file system 112 such as a cloud-based AWS s3 file system. In one embodiment this information package (PDF report) includes the offering memorandum, the carbon offsetting action related data submitted to the national carbon registry (including any information captured by the data acquisition system and devices described above), the VER certificate (e.g. the CCER in China) and the VER redemption/redemption certificate (for example, it is known in China as the Certificate of Redemption of Certified Emission Reduction). The information package may be a single document or a collection of documents and may be provided in a container or similar file or data structure.

The exchange reviews the submitted information package (PDF report) and if the package meets the listing criteria, then it will approve the listing and digitally sign at least the VER certificate and VER redemption certificate, and preferably digitally sign the entire information package with a Hash algorithm or hash function (e.g. a 256 bit hash). This hash function may be stored on the blockchain (for example within the smart contract) to act as proof the exchange has approved the information package, and allow verification that the information package has not been altered. In one embodiment when the information package is accessed, the hash is provided and used to authenticate that the information package has not been altered (and the information package may only be served if the authentication is passed).

The application 111 submits (e.g. by a service call) the information package address (VER report URI, however this could also be a URL) along with the digital signature (hash) to a VER smart contract 154. In this embodiment the blockchain is an Ethereum blockchain and the VER smart contract 154 is based upon (or inherited from) an ERC721 smart contract. The time sequence of VER smart contracts 154 create a NFDT of a real world asset/activity (i.e. the carbon offsetting activity). The smart contract saves the information of the asset into the blockchain to provide a non-tampering certificate. In this embodiment the information of the asset includes name, ID, CO2 reduction amount (e.g. in units of tCO2e), the download address (e.g. URI or URL) of the information package (e.g. PDF report), the signature of the information package (hash of the PDF report), and a URI of a JSON metadata file (as per the ERC 721 standard; token_URI). Similar to the real world, an NFDT is the digital birth certificate. Thus, the signed listing documentation including the information package (and VER certificate and VER redemption certificate) forms the birth document package for the NFDT.

In some embodiments the national registries that issue voluntary emission reduction (VER) certificates and retirement certificates may be NFDTs based registry systems. These registries are configured to receive and store the information packages and write the smart contracts to a blockchain (public or private), which is then used to generate issuance of the VER certificate. Similarly a request to retire a VER may be handled by a smart contract on the blockchain which verifies the information in the request and records the retirement in the blockchain, and issues a retirement certificate. The VER certificates and retirement certificates could be issued as Asset Backed Tokens. The registry could be used to record carbon credits of assets, and issue VERs or it may be carbon foot print registry which records the carbon footprint of an asset, for example to meet NDC requirements, or it may be carbon neutrality registry which stores the carbon neutrality status of an asset, potentially working with a carbon credit registry and carbon footprint registry. In each case the registry would implement an embodiment of the above described NFDT method to allow an asset holder to submit information on an asset including carbon data which can be independently verified to allow the carbon footprint of the asset to be determined, and in the case of emission reductions, allow VER certificates to be created and information stored in the blockchain regarding the carbon neutrality status of the asset. The registry could also allow redemption of VERs to be recorded and allow generation of CNTs. Further as changes occur to the asset over time (e.g. further emissions or reductions) these can be recorded in the NFDT for the asset maintained by the registry.

The registry may also provide management, review, certification, verification and legal services including define procedures and rules for use of the registry and ensure regulatory compliance. The registry may also liaise with third party verification services. The registry may also include or manage the computational infrastructure, including management of cloud based computer apparatus and application of security policies and procedures, and providing interfaces for interacting with third party services such as verification services or public blockchains. The registry may host computational nodes of the blockchain and may lease and configure cloud servers from cloud providers (e.g. Amazon, Microsoft, Google). The registries could also be provided as part of a trading platform or otherwise linked to a trading platform and may be configured to issue CNTs based on the issued certificates. The registry thus provides the computational platform to create NFDTs as well as various approval, regulatory and certification processes required to implement the registry. In some embodiment the registry is a national registry or an accredited registry which may be accredited by a government or other agency.

That is the NFDT based Carbon Registry is a Carbon Registry which acts as the issuing authority of VERs in a first country and which is also configured to store a plurality of NFDTs for a plurality of assets in the first country. That is the Carbon Registry implements the computational system for generating NFDTs for recording carbon attributes of assets and is further configured to issue voluntary emission reduction certificates and redemption certificates to the asset owner based on the NFDT of the respective asset. The Carbon Registry may form part of a larger system such as an international Carbon Registry or as part of a Carbon Trading Platform.

Every NFDT is identified by a unique uint256 ID inside the ERC-721 smart contract. This identifying number is fixed and thus cannot be changed for the life of the contract. The pair (contract address, uint256 tokenId) will then be a globally unique and fully-qualified identifier for a specific asset on an Ethereum chain. The choice of uint256 allows a wide variety of applications because UUIDs and SHA3 hashes are directly convertible to uint256. After a NFDT is generated the record will persist on the blockchain (and not disappear). ERC-721 standardizes a safe transfer function safeTransferFrom (overloaded with and without a bytes parameter) and an unsafe function transferFrom. Transfers may be initiated by the owner of an NFDT, the approved address of an NFDT or an authorized operator of the current owner of an NFDT. Additionally, an authorized operator may set the approved address for an NFDT. This provides a powerful set of tools for wallet, broker and auction applications to quickly use a large number of NFDTs.

Table 4 below illustrates a smart contract for issuing a CCER Asset Contract based on ERC-721 according to an embodiment. This could be modified for other voluntary emission reduction (VER) based assets. This asset contract can be used for recording the carbon emissions (e.g. the carbon footprint of an asset) or emissions reductions.

TABLE 4
Smart Contract Code for CCER Asset Contract based on ERC-721 (CCERAsset.sol)

```
// contracts/CCERAsset.sol
pragma solidity \hat{ }0.8.0;
import ″@openzeppelin/contracts/token/ERC721/ERC721.sol″;
import ″@openzeppelin/contracts/token/ERC721/extensions/ERC721URIStorage.sol″;
import ″@openzeppelin/contracts/utils/Counters.sol″;
import ″@openzeppelin/contracts/access/AccessControl. sol″;
import ″. /ICNTToken.sol″;
import ″. /ICarbonFootprint.sol″;
contract CCERAsset is ERC721URIStorage, AccessControl {
  // Create a new role identifier for the minter role
  bytes32 public constant ISSUER_ROLE = keccak256(″ISSUER_ROLE″);
  struct EmissionData {
    uint256 co2; // stores the amount of CO2 emissions/reductions
  }
  struct Certificate {
    string websiteUrl; // each CCER project is published on the official website
    string reportUrl; // URL of where PDF report is stored
    string reportHash; // hash of the PDF report
  }
  // CCER Report struct is used to descript the CCER key properties
  struct CCERItem {
    uint256 id; //unique ID for the contract
    string assetId; //ID assigned by CCER acrredited org to identify CCER project
    string assetName; // The assigned name of the CCER project
    string description; // key points of report in text formart
    string tokenURI; //points to JSON file including metadata of NFT
    EmissionData emissionData; // see above
    Certificate certificate; // see above
  }
  using Counters for Counters.Counter;
  Counters.Counter private _tokenIds;
  using Strings for uint256;
  mapping(string => uint256) private _hashTokenMapping;
  mapping(uint256 => CCERItem) private _ccerReportMapping;
  mapping(uint256 => uint256[ ]) private _tokenIdMapping;
  mapping(uint256 => uint256[ ]) private _childTokenIds;
  address private _carbonFootprintContractAddress;
  address private _tokenContractAddress;
  constructor(address administrator) ERC721(″CCER Asset″, ″CRA″) {
    _setupRole(DEFAULT_ADMIN_ROLE, administrator);
  }
  function _setHashToken(string memory hash, uint256 tokenId)
    internal
    virtual
  {
    _hashTokenMapping[hash] = tokenId;
  }
  function _setTokenCcer(uint256 tokenId, CCERItem memory ccer)
    internal
    virtual
  {
    _ccerReportMapping[tokenId] = ccer;
  }
  function _existsHash(string memory hash)
    internal
    view
    virtual
    returns (bool)
  {
    return _hashTokenMapping[hash] != 0;
  }
  // create a new token for a ccer asset, save it blockchain and assign it to recipient
  function create(
    address recipient,
    string memory ccerName,
    string memory ccerId,
    string memory description,
    uint256 co2,
    string memory websiteURI,
    string memory reportURI,
    string memory reportHash,
    string memory tokenURI
  ) public onlyRole(ISSUER_ROLE) returns (uint256) {
    // check hash whether has used by the contract, if so throw a exception
    require(!_existsHash(reportHash), ″CCERAsset: ccre report already committed
″);
    _tokenIds.increment( );
    uint256 newItemId = _tokenIds.current( );
    _mint(recipient, newItemId);
    _setTokenURI(newItemId, tokenURI);
    // save hash and token id in mapping
    _setHashToken(reportHash, newItemId);
    // save ccer asset into memory with token id
    EmissionData memory emissionData = EmissionData(co2);
    Certificate memory certificate = Certificate(websiteURI, reportURI, reportHash);
    CCERItem memory ccer = CCERItem(
      newItemId,
      ccerId,
      ccerName,
      description,
      tokenURI,
      emissionData,
      certificate
    );
    _setTokenCcer(newItemId, ccer);
    return newItemId;
  }
  // approve a ccer asset. once the ccer asset is approved, the contract will call
another ERC 20 contract (CNT Token contract) to issue the CNT tokens to owner of
the ccer asset.
  function approveCCERAsset(uint256 amount, uint256 tokenId721)
    public
    onlyRole(DEFAULT_ADMIN_ROLE)
  {
    // get the address of owner of the ccer asset token
    address recipient = ERC721.ownerOf(tokenId721);
    // link to CNT token contract and call issue function to issue the CNT token
to the owner of the ccer asset token
    ICNTToken cntToken = ICNTToken(_tokenContractAddress);
    cntToken.issue(recipient, amount, tokenId721);
  }
  // create a new carbon footprint token for the ccert asset, the carbon footprint
  // is another a ERC 721 contract, and assign the carbon footprint to owner of the
  // ccer asset. That is the CCERitem is created first (the birth contract), and
  // then addCarbonfootprint is used for subsequent contracts in the time series
  function addCarbonFootprint(
    string memory reportURI,
    string memory reportHash,
    string memory description,
    string memory tokenURI,
    uint256 tokenId
  ) public returns (uint256) {
    ICarbonFootprint carbonFootprint = ICarbonFootprint(
      _carbonFootprintContractAddress
    );
    // get the address of owner of the ccer asset token
    address recipient = ERC721.ownerOf(tokenId);
    uint256 carbonFootprintTokenId = carbonFootprint.create(
      recipient,
      reportURI,
      reportHash,
      description,
      tokenURI,
      tokenId
    );
    uint256[ ] storage tokenIdList = _childTokenIds[tokenId];
    tokenIdList.push(carbonFootprintTokenId);
    return carbonFootprintTokenId;
  }
  // get all carbon foot print tokens for the token id of ccer asset
  // this allows all contracts in the time series to be obtained/reviewed
  function getCarbonFootprintIdsByParentTokenId(uint256 parentTokenId)
    public
    view
    virtual
    returns (uint256[ ] memory)
  {
    uint256[ ] memory tokenIdList = _childTokenIds[parentTokenId];
    return tokenIdList;
  }
  // grant a user (address) Issuer Role, only allow the administrator role to call
the function
  function grantIssuerRole(address account)
    public
    onlyRole(DEFAULT_ADMIN_ROLE)
  {
    grantRole(ISSUER_ROLE, account);
  }
  // set address of carbon footprint contract (ERC 721)
  function setCarbonFootprintContractAddress(address carbonFootprintContractAddress)
    public
    onlyRole(DEFAULT_ADMIN_ROLE)
  {
    _carbonFootprintContractAddress = carbonFootprintContractAddress;
  }
  // set address of CNT token contract (ERC 20), the CNT token contract is used to
issue to CNT token to recipient
  function setTokenContractAddress(address tokenContractAddress)
    public
    onlyRole(DEFAULT_ADMIN_ROLE)
  {
    _tokenContractAddress = tokenContractAddress;
  }
  // revoke a user (address) Issuer Role, only allow the administrator role to call
the function
  function revokeIssuerRole(address account)
    public
    onlyRole(DEFAULT_ADMIN_ROLE)
  {
    revokeRole(ISSUER_ROLE, account);
  }
  /**
  * get ccer asset by token id
  */
  function getCcerByTokenId(uint256 tokenId)
    public
    view
    virtual
    returns (CCERItem memory)
  {
    require(_exists(tokenId), ″CCERAsset: URI query for nonexistent token″);
    CCERItem memory ccer = _ccerReportMapping[tokenId];
    return ccer;
  }
  /**
  * get ccer asset by report hash
  */
  function getCcerByHash(string memory hash)
    public
    view
    virtual
    returns (CCERItem memory)
  {
    require(
      _existsHash(hash),
      ″CCERAsset: ccer report query for nonexistent hash″
    );
    uint256 tokenId = _hashTokenMapping[hash];
    CCERItem memory ccer = _ccerReportMapping[tokenId];
    return ccer;
  }
  /**
  * overrive support interfaces
  */
  function supportsInterface(bytes4 interfaceId)
    public
    view
    virtual
    override(ERC721, AccessControl)
    returns (bool)
  {
    return
      interfaceId == type(IERC721).interfaceId | |
      interfaceId == type(IERC721Metadata).interfaceId | |
      interfaceId == type(IAccessControl).interfaceId | |
      super.supportsInterface(interfaceId);
  }
}
// contracts/ICarbonFootprint.sol
pragma solidity \hat{ }0.8.0;
interface ICarbonFootprint {
  function create(
    address recipient,
    string memory reportURI,
    string memory reportHash,
    string memory description,
    string memory tokenURI,
    uint256 ccerAssertTokenId
  ) external returns (uint256);
}
// contracts/ICNTToken.sol
pragma solidity \hat{ }0.8.0;
interface ICNTToken {
  function issue(address account, uint256 amount, uint256 tokenId721) external;
}
// contracts/CarbonFootprint.sol
pragma solidity \hat{ }0.8.0;
import ″@openzeppelin/contracts/token/ERC721/ERC721.sol″;
import ″@openzeppelin/contracts/token/ERC721/extensions/ERC721URIStorage.sol″;
import ″@openzeppelin/contracts/utils/Counters.sol″;
import ″@openzeppelin/contracts/access/AccessControl.sol″;
import ″./ICarbonFootprint.sol″;
contract CarbonFootprint is ERC721URIStorage, AccessControl, ICarbonFootprint {
  // Create a new role identifier for the minter role
  bytes32 public constant ISSUER_ROLE = keccak256(″ISSUER_ROLE″);
  struct FootprintItem { // see struct CCERItem for description of fields
    uint256 ccerAssertTokenId;
    string reportUrl;
    string reportHash;
    string description;
    uint256 tokenId;
    string tokenURI;
    uint256 tokenId;
  }
  using Counters for Counters.Counter;
  Counters.Counter private _tokenIds;
  using Strings for uint256;
  mapping(string => uint256) private _hashTokenMapping;
  mapping(uint256 => FootprintItem) private _footprintMapping;
  // Child tokenId, Parent tokenId
  // links CCERAsset to the carbonfootprint (e.g. to create the time series)
  mapping(uint256 => uint256) private _tokenIdMapping;
  constructor(address administrator) ERC721(″CCER Carbon Footprint″, ″CCF″) {
    _setupRole(DEFAULT_ADMIN_ROLE, administrator);
  }
  function _setHashToken(string memory hash, uint256 tokenId)
    internal
    virtual
  {
    _hashTokenMapping[hash] = tokenId;
  }
  function _setTokenCcer(uint256 tokenId, FootprintItem memory footprintItem)
    internal
    virtual
  {
    _footprintMapping[tokenId] = footprintItem;
  }
  function _existsHash(string memory hash)
    internal
    view
    virtual
    returns (bool)
  {
    return _hashTokenMapping[hash] != 0;
  }
  // create a new token and then assign it to recevier
  // onlyRole(ISSUER_ROLE)
  function create(
    address recipient,
    string memory reportURI,
    string memory reportHash,
    string memory description,
    string memory tokenURI,
    uint256 ccerAssertTokenId
  ) public override virtual returns (uint256) {
    // check hash whether has used by the contract, if so throw a exception
    require(! _existsHash(reportHash), ″CCERAsset: ccre report already committed
″);
    _tokenIds.increment( );
    uint256 newItemId = _tokenIds.current( );
    _mint(recipient, newItemId);
    _setTokenURI(newItemId, tokenURI);
    // save hash and token id in mapping
    _setHashToken(reportHash, newItemId);
    // save ccer asset into memory with token id
    FootprintItem memory footprintItem = FootprintItem(
      ccerAssertTokenId,
      reportURI,
      reportHash,
      description,
      tokenURI,
      newItemId
    );
    _setTokenCcer(newItemId, footprintItem);
    _setCcerAssertTokenId(newItemId, ccerAssertTokenId);
    return newItemId;
  }
  // set ccer assert id for the carbon footprint
  function _setCcerAssertTokenId(uint256 tokenId, uint256 ccerAssertTokenId)
    internal
    virtual
  {
    _tokenIdMapping[tokenId] = ccerAssertTokenId;
  }
  // get ccer asset token id of the carbon footprint
  function getCcerAssertTokenIdByTokenId(uint256 tokenId)
    public
    view
    virtual
    returns (uint256)
  {
    uint256 ccerAssertTokenId = _tokenIdMapping[tokenId];
    return ccerAssertTokenId;
  }
  // grant a user (address) Issuer Role, only allow the administrator role to call
the function
  function grantIssuerRole(address account)
    public
    onlyRole(DEFAULT_ADMIN_ROLE)
  {
    grantRole(ISSUER_ROLE, account);
  }
  // revoke a user (address) Issuer Role, only allow the administrator role to call
the function
  function revokeIssuerRole(address account)
    public
    onlyRole(DEFAULT_ADMIN_ROLE)
  {
    revokeRole(ISSUER_ROLE, account);
  }
  /**
  * get carbon footprint of a ccer asset by token id
  */
  function getFootprintByTokenId(uint256 tokenId)
    public
    view
    virtual
    returns (FootprintItem memory)
  {
    require(_exists(tokenId), ″Carbon Footprint of the CCER: URI query for none
xistent token″);
    FootprintItem memory footprintItem = _footprintMapping[tokenId];
    return footprintItem;
  }
  /**
  * get carbon footprint of a ccer asset by report hash
  */
  function getFootprintByHash(string memory hash)
    public
    view
    virtual
    returns (FootprintItem memory)
  {
    require(
      _existsHash(hash),
      ″Carbon Footprint of the CCER: Carbon Footprint query for nonexistent
hash″
    );
    uint256 tokenId = _hashTokenMapping[hash];
    FootprintItem memory footprintItem = _footprintMapping[tokenId];
    return footprintItem;
  }
  /**
  * overrive support interfaces
  */
  function supportsInterface(bytes4 interfaceId)
    public
    view
    virtual
    override(ERC721, AccessControl)
    returns (bool)
  {
    return
      interfaceId == type(IERC721).interfaceId | |
      interfaceId == type(IERC721Metadata).interfaceId | |
      interfaceId == type(IAccessControl).interfaceId | |
      super.supportsInterface(interfaceId);
  }
}
```

Table 5 below provides code for a Carbon Neutrality Token (CNT) Contract based on ERC-20 for issuing an amount of CNT tokens to an account.

TABLE 5
Carbon Neutrality Token (CNT) Contract based on ERC-20 (CNTToken.sol).

```
// contracts/CNTToken.sol
pragma solidity \hat{ }0.8.0;
import ″@openzeppelin/contracts/access/AccessControl.sol″;
import ″@openzeppelin/contracts/token/ERC20/ERC20.sol″;
import ″./ICNTToken.sol″;
contract CNTToken is ERC20, AccessControl, ICNTToken {
  struct ReportItem {
    uint256 tokenId721;
    address recipient;
    uint256 amount;
  }
  mapping (uint256 => uint256) private _tokenId721s;
  mapping (uint256 => ReportItem) private _reportItems;
  // Create a new role identifier for the minter role
  bytes32 public constant ISSUER_ROLE = keccak256(″ISSUER_ROLE″);
  constructor(address administrator) ERC20(″Carbon Neutrality Token″, ″CNT″) {
    // Grant the contract deployer the default admin role: it will be able
    // to grant and revoke any roles
    _setupRole(DEFAULT_ADMIN_ROLE, administrator);
  }
  // The minimum unit of CNT is 1
  function decimals( ) public view virtual override returns (uint8) {
    return 0;
  }
  // Creates ‘amount‘ tokens and assigns them to ‘account‘
  // onlyRole(ISSUER_ROLE)
  function issue(address account, uint256 amount, uint256 tokenId721)
    override virtual public
  {
    // Verify that the tokenId has been issued
    //require(_tokenId721s[tokenId721] == tokenId721, ″this report has been rel
eased″);
    ReportItem memory reportItem = ReportItem (
      tokenId721,
      account,
      amount
    );
    _setReportItem(tokenId721, reportItem);
    //_tokenId721s[tokenId721] = tokenId721;
    _mint(account, amount);
  }
  function _setReportItem (uint256 tokenId721, ReportItem memory reportItem) inte
rnal {
    //
    _reportItems[tokenId721] = reportItem;
  }
  function getReportItem (uint256 tokenId721) public view virtual returns (ReportI
tem memory) {
    ReportItem memory reportItem = _reportItems[tokenId721];
    return reportItem;
  }
  // Grant an account ″Issuer role″, the role is used to generate a new tokan and
  then assign it to a address
  function grantIssuerRole(address account)
    public
    onlyRole(DEFAULT_ADMIN_ROLE)
  {
    grantRole(ISSUER_ROLE, account);
  }
  // Revoke the ″Issuer role″ from the account (address)
  function revokeIssuerRole(address account)
    public
    onlyRole(DEFAULT_ADMIN_ROLE)
  {
    revokeRole(ISSUER_ROLE, account);
  }
  // override, only allow the administrator role to call the function
  function transfer(address recipient, uint256 amount)
    public
    virtual
    override
    onlyRole(DEFAULT_ADMIN_ROLE)
    returns (bool)
  {
    return ERC20.transfer(recipient, amount);
  }
  // override, only allow the administrator role to call the function
  function allowance(address owner, address spender)
    public
    view
    virtual
    override
    onlyRole(DEFAULT_ADMIN_ROLE)
    returns (uint256)
  {
    return ERC20.allowance(owner, spender);
  }
  // override, only allow the administrator role to call the function
  function approve(address spender, uint256 amount)
    public
    virtual
    override
    onlyRole(DEFAULT_ADMIN_ROLE)
    returns (bool)
  {
    ERC20.approve(spender, amount);
    return true;
  }
  // override, only allow the administrator role to call the function
  function transferFrom(
    address sender,
    address recipient,
    uint256 amount
  ) public virtual override onlyRole(DEFAULT_ADMIN_ROLE) returns (bool) {
    _transfer(sender, recipient, amount);
    return ERC20.transferFrom(sender, recipient, amount);
  }
  // override, only allow the administrator role to call the function
  function increaseAllowance(address spender, uint256 addedValue)
    public
    virtual
    override
    onlyRole(DEFAULT_ADMIN_ROLE)
    returns (bool)
  {
    return ERC20.increaseAllowance(spender, addedValue);
  }
  // override, only allow the administrator role to call the function
  function decreaseAllowance(address spender, uint256 subtractedValue)
    public
    virtual
    override
    onlyRole(DEFAULT_ADMIN_ROLE)
    returns (bool)
  {
    return ERC20.decreaseAllowance(spender, subtractedValue);
  }
}
```

The code shown in Tables 4 and 5 define an CCERAsset Smart Contract and a CNT token contract in relation to a CCER project according to an embodiment. The data structures EmissionData, Certificate, and CCERItem defines the fields (or elements/variables/attributes) stored by a CCERAsset smart contract. The emissionData struct has a field “co2” which is used to store the amount of CO2 emissions or reductions in units of tCO2e. The certificate structure is used to store information about CCER verification and redemption certificates. Each CCER project is published on an official website, and assigned a unique ID and name. The certificate struct thus includes a field websiteURL to store the URL which can be used to access the website for the CCER project. Similarly the CCERItem struct has two fields called assetID and assetName for storing the assigned ID and name of the CCER project. The certificate struct is also used to store the URL of the report (or information package) that includes the CCER certificate (and redemption certificate) in the reportUrl field along with the hash used to authenticate that the report has not been altered in the reportHash field. The CCERItem data structure also include a description field which includes key points of the report in text format. The field tokenURI points to a JSON file that includes metadata of the NFT (see https://eips.ethereum.org/EIPS/eip-721 for an example).

The function approveCCERAsset is used to call the CNT token contract to issue CNTs to the owner of the asset once the CCERAsset is approved. To create a time series of linked contracts in which the subsequent contracts include additional emissions (or reductions) since the previous contract, the CCERAsset contract includes an addCarbonFootprint function, and Table 4 lists the code for the CarbonFootprint contract. The data structure FootprintItem in the CarbonFootprint contract has equivalent fields to the CCERItem fields. That is the CCERAsset contract is created first as the birth contract, and then additional CarbonFootprint contracts are added to the blockchain and linked together. The function getCarbonFootprintIdsByParentTokenId gets all the carbon foot print tokens for the token id of the CCER asset and thus allows all of the contracts in the time series to be obtained.

The code shown in Tables 4 and 5 represent code for AssetContract and CNTs for execution and storage on an Ethereum blockchain based on the ERC721 (Non-Fungible Token) and ERC 20 (Fungible Token) Ethereum standards. More details may be found at https://eips.ethereum.org/EIPS/cip-721 and https://cips.ethereum.org/EIPS/cip-20. See also https://ethereum.org/en/, https://ethereum.org/en/developers/docs/standards/tokens/erc-721/, and https://docs.openzeppelin.com/contracts/3.x/erc721. Extension code can also be written based on this pseudocode to implement specific interfaces or features such as use of snapshots and error checking as required. Similar code can be we written for other blockchains based on the above code and the code could be modified for use with other types of emission reduction certificates (besides a CCER certificate) or for other attributes for other NFDTs. Similarly some (or all) of fields such as websiteUrl, assetName, assetID and description could be consolidated for example in the report obtained at reportURL and could thus be omitted. The reportUrl and reportHash could be for a single report (or information package) containing all relevant information about the asset. Alternatively the information package could be split into multiple documents, each with a separate reportUrl and hash, such as a verification certificate, a redemption certificate, a project description, and any other associated documents that may be relevant to the project or listing on an exchange. More generally the report address (and in fact all addresses) could be Uniform Resource Identifier (URI) addresses instead of Uniform Resource Locator (URL) addresses. Whilst a URL define the location of a resource, a URIs identify the resource by name at a location (or URL), and thus URLs are a subset of URIs. Report address will be used to define either a URI or URL address.

As illustrated in FIG. 1E, the VER asset contract 154 is published on the blockchain at a block address (VER smart contract address) and acts as a digital birth certificate. The VER report (information package) is stored in the description section of the contract. The block information (block address) of the published VER asset contract is received 174 by the application 111 and saved 175 into a database 113 such as an AWS RDS database. The exchange approves the VER report (information package) 176 and this approval 176 triggers execution (or calls) a CNT token contract 156 (generated via a ERC 20 smart contract, as illustrated above in Table 5) to issue (or generate) CNT tokens according to the amount of CO2 emission reductions included in the VER report (information package) to an account. The issued CNT tokens are then listed 178 against the asset (and asset holder) in a ledger 114. In one embodiment the CNTs are stored in a cold wallet of the trading platform for closed-end custody. Alternatively, they may be stored on a public blockchain or in some other storage location. When a document saved in the URL or anywhere is called upon by existing or potential investor of the CNT (or any Asset Backed Token investor), the document is verified through its Hash code for the corresponding ERC721 contract to guarantee its authenticity.

This VER asset contract 154 thus corresponds to the birth information package signed by the trading exchange. Subsequent data generated by the real world asset such as further documentation or captured through the data acquisition system, for example on a daily, monthly, quarterly or annually basis, is submitted to the exchange to form a subsequent (or follow-on) information package with a time stamp (time 1). Each time when such a subsequent time stamped information package is submitted to the exchange the application 111 will use the information package to create another VER asset contract that is linked to the previous VER asset contract.

That is any new information submitted to the exchange will be captured by following VER asset contract. As such each following VER asset contract will not only have one description of uint256 ID of the information at this time t, but also has another description linked to the address of the VER asset contract of the previous information submitted to the exchange (i.e. at t-1). This enables the creation of a time sequence of linked emission reduction smart contracts which form the NFDT representing the real world asset with live information flow of carbon neutrality status. The digital representation of the asset is thus a time series (or time ordered chain) of smart contracts.

Thus, the birth information package as signed by exchange, and all following information packages with time stamps, forms a live and sequential real world information flow of the carbon neutrality status for the real world asset. The NFDTs are created in the blockchain to mirror and protect the authenticity of the real world information in the digital world.

Similar to the listing of a carbon emission reduction activity and generation of CNTs through the submission of an information package as illustrated in FIG. 1E, asset holders may apply to the exchange to list an asset as illustrated in FIG. 1B and Table 4. In this embodiment the asset holder 130 prepares an information package comprising carbon emission related data of the asset, and the data is used to calculate the carbon footprint attribute value of the asset (ENV value). This calculation may be performed by the asset holder 130 and verified by the third party entity 140 or the asset holder may submit the information to the third party entity 140 to perform the calculation. This certification is included in the information package which is uploaded to a file system 112. The trading exchange reviews the submitted information package and if the package meets the listing criteria, then will approve the listing and digitally sign the package. This is submitted to a smart contract such as the VER asset contract 154 or a similar contract to generate an NFDT representing the asset and which stores (and thus binds) the carbon footprint attribute value (ENV value) to the NFDT (digital twin) of the asset at the time of birth. This is then approved and saved into the database 113 and the asset may then be listed on the exchange. If the ENV value of the asset is positive then an appropriate amount (or number) of CNT tokens are issued using the CNT token contract 156. If the ENV value is negative then the asset holder may then purchase CNT tokens from a CNT token holder to achieve a net zero carbon neutrality value. This may be performed using the safe TransferFrom or transferForm interface of the VER asset contract, or by another smart contract, and details of the transaction are stored on the blockchain. Additionally (and as discussed above), in the case of an asset that continuously (or subsequently) produces additional emissions, such as thermal power plan, chemical plants, etc, a further information package may be submitted to the exchange to record the additional emissions at a subsequent time t and the ENV value of the asset is then updated with this transaction recorded on the blockchain. The transaction may be linked to the previous transaction to provide a chain of traceable transactions.

When the VER is redeemed (or retired) in one jurisdiction, the redemption certificate issued by the national registry will be locked into a custody directly controlled by the exchange (or a trusted party). This is to prevent the redemption certificate from being used by the owner for any other purposes. Also, in an application for issuance of CNTs, a third party may be used to verify and certify the authenticity of the redemption certificate.

When an asset is traded, the carbon footprint attribute (ENV) attached to the asset flows with it, and the purchaser is credited with the carbon footprint attribute (ENV) attached to the asset. The asset here can be a traditional asset such as a building or a share of a factory, a cryptocurrency such as BTC or ETH, or an alternative real asset such as artwork, jewellery, etc. The CNTs may be generated or obtained from companies with positive carbon offsets or carbon captures (e.g., photovoltaics, wind energy, forest projects), companies owning products or assets that have carbon emissions below a recognized industry benchmark, or even companies or scenarios that aggregate the green contributions of consumers/individuals in society (e.g., companies of shared mobility, distributed renewable energy and low and/or negative carbon consumer products manufacture). The correspondence between CNT and negative ENV may be 1:1; alternatively, some other correspondence may be used as desired. The CNTs can be customized by a trading platform; and a trader or an asset holder having a negative ENV can buy CNTs to increase its total ENV value (which is tracked in the ledger). In other words, the total ENV value of a trader's portfolio or an asset holder is equal to the sum of carbon footprint attribute values of all assets of the trader or asset holder, and a positive carbon footprint attribute value corresponding to the CNTs that the trader or asset holder holds. The carbon footprint attribute value ENV and carbon neutrality tokens CNTs can be calculated or audited by a professional third party entity to avoid data falsification. When investors on the exchange buy CNTs, they can use CNT for two purposes. The first purpose is to keep the CNT alive such as for a trading purpose or its own financial trading account for carbon footprint management purpose. The investor can buy and sell the CNT anytime to make a profit and gain, and the investor's portfolio will reflect the carbon value of all assets. The investor may also permanently freeze the CNT. The investor can thus buy same amount of CNT on the exchange and then make request to exchange that they wish to burn the CNT to neutralize their carbon footprint in real world.

FIGS. 2B to 2F further illustrate embodiments. FIG. 2B is a schematic diagram of an asset owner 220 with a positive environmental footprint (positive ENV) 222 which is used to generate carbon neutrality tokens (CNTs) according to an embodiment. Every asset produces 2 values: Financial data and/or operational data 224 and Environmental (ENV) data 222. The environmental data comprises offset data collected from the asset. The data may be collects using a secure data acquisition system as described below. The ENV data 222 is verified 226 by a third party authority and used to use CNTs. Additionally financial and operational data 224 is prepared and verified by third party accountants and lawyers who provide additional or supporting documents to verify the financial and operational data 228. An offering memorandum is filed with the exchange 230 (CTX) and reviewed by a listing committee. Asset Backed Tokens (ABT) may then be issued and listed on the exchange 230, where each asset backed token is based on one or more financial and/or operational metrics from the financial and/or operational data with zero ENV. ABT and CNTs may be traded on the digital exchange 230. CNTs can then be used to carbon neutralize a real world asset 232. That is an entity in real world with carbon footprint, can buy CNT on the exchange 230 and permanently freeze it, and use them to neutralize its real world carbon footprint, and obtain a carbon neutrality certificate, and the exchange (CTX) will save information of such a behaviour on to Carbon Neutrality Block Chain. A financial investor 234 can buy from the exchange (CTX) a CNT, an ABT or both and the carbon footprint of portfolio is updated based on the purchases to obtain a positive or zero ENV portfolio 236 on the exchange.

FIG. 2C is a schematic diagram of an asset owner 220 with a positive environmental footprint (positive ENV) which is used to generate voluntary emission reduction certificates which are sold to a purchaser 246 who uses the voluntary emission reduction certificates 242 to obtain carbon neutrality tokens (CNTs) 252 and generate an NFDT 250 representing the asset on an Ethereum blockchain 254 according to an embodiment. This figure illustrates registration of the offsetting activity with a national carbon registry 240, issuance of a voluntary emission reduction certificate which is then frozen in the carbon registry which triggers issuance of a redemption certificate. This may be done by the original asset owner, or by a purchaser 246. As discussed above these are submitted to the exchange 230 which allows creation of the NFDT and CNTs which may be traded outside of the original county which issued the VER.

FIG. 2D is a schematic diagram of an asset owner 260 with a negative environmental footprint (negative ENV) 262 (i.e. generates carbon emissions) which is listed on the digital asset trading exchange 230, in which the negative carbon footprint can be offset by an investor 232 by also purchasing CNTs according to an embodiment. As discussed in FIG. 2B, the financial and/or operational data is prepared and submitted to the exchange which issues asset backed token (ABT) with negative ENV based on this information, such as one or more numerical/quantitative metrics within the financial and/or operational data (e.g. profit, revenue, number of products sold, production rate, uptime or percentage uptime, etc). The ABTs with negative ENV may be traded by the asset owner, who may buy some CNTS to offset the negative ENV. Alternatively or additionally CNTs may be bundled with listed assets to enable the asset owner to satisfy ESG requirements from shareholders or listing venue.

FIG. 2E is a flowchart of a method for creating an NFDT 250 for representing an asset 220 with a positive environmental footprint (positive ENV 222) according to an embodiment. At times T0, T+1 and T+2, we obtain carbon emissions reduction certificates 242, redemption certificates 244 and uses this publish a series of smart contracts 250 where each smart contract links to the previous smart contract, and are used to generate CNTs 252.

FIG. 2F is a flowchart of a method for creating an NFDT 274 for representing an asset 260 with a negative environmental footprint (negative ENV; 262) according to an embodiment. The offering memorandum 272 captures the carbon emissions of the asset at the time of listing and is used to form the birth contract at TO. Quarterly reports are then generated, each of which capture additional emissions, and each of which are used to publish additional smart contracts to form a time series of linked smart contracts 274 which may be used to issue asset backed tokens ABTs, and the ENV value on the ledger is updated after each smart contract 276.

In some embodiments, the CNT holder 120 might not hold assets to be traded in the exchange such as when the CNT holder 120 is an individual or an environmental organization, which simply contribute to carbon offsetting by performing green actions, such as green transportation, planting trees and waste sorting, which can be captured and aggregated and used to generate CNTs. For example, if in one year 10,000 tCO2e of positive ENV from green transportation by consumers are aggregated, 10,000 CNTs can be generated on the CNT chain. The economic benefits brought by the CNTs can be distributed to the consumers through the platform, thus promoting green consumption.

In some embodiments supporting systems may be used to assist in issuing CNTs. For example, the supporting system may include a data acquisition module for acquiring carbon offsetting action related data from the CNT holder that performs the carbon offsetting action; a calculation module, for assisting third party entity in calculating the positive ENV and the amount of carbon neutrality tokens corresponding to the positive ENV based on the carbon offsetting action related data, wherein the calculating method may be provided by the third party entity or provided by the supporting system and approved by the third party entity; a certification module, for assisting the third party entity in generating a secure digital certificate associated with the amount of CNTs; a communication module, for providing the amount of CNTs and the secure digital certificate in real time to a blockchain for triggering a smart contract, wherein the smart contract may also be provided by the supporting system. Furthermore, according to an embodiment, the blockchain may also be provided by the supporting system.

For a traditional physical asset, calculating its ENV requires consideration of how long the asset has been held and how the carbon emission of the asset may change over time.

For a commodity/product-based asset, e.g., gold, diamond and bitcoin, its carbon footprint or emission is generated once and for all in the process of acquisition, discovery or production of the commodity/product, and the ENV of the asset and the time of acquisition are recorded in carbon footprint attribute value included in the smart contract of the NFDT at the time of issuance and is thus bound to the asset. For these assets the ENV does not generally change over time, and thus the NFDT may be just the birth contract including the ENV value. A ledger may also be used to store the ENV value.

For example, a mined digital currency such as Bitcoin (BTC) does not generate carbon emissions itself; however, the process of acquiring the virtual asset may consume energy, and the same amount of virtual asset may generate different amounts of carbon emissions.

Different types of companies or projects may use different methods for calculating, especially for virtual assets such as bitcoin. Calculation methods for different asset categories including bitcoin, green transportation, photovoltaic and wind energy generation, and building distributed energy resource system are described below as examples.

Multiple NFDTs can be combined to create more complex systems including hierarchical systems. For example an international carbon trading system could comprise a Carbon Credit Blockchain Registry, a Carbon Neutrality Blockchain Registry, and a Carbon Footprint Blockchain registry each of which represent assets by NFDTs. The Carbon Credit Blockchain Registry contains national registries each of which implementing NFDTs to capture carbon credits generated from assets over time. The Carbon Neutrality Blockchain Registry contains national registries each of which stores neutrality events as NFTs, or which records the neutrality status of assets. The Carbon Footprint Blockchain registry contains national registries which use NFDTs to track the carbon footprint of assets, such as emissions by assets over time. This system allows generation and trading of CNTs across national borders. The various registries may be implemented using NFDT based registries in which each registry implements embodiments of the methods described herein for generating NFDT representations of assets in which the attributes are related to carbon (e.g. offsets and emissions). That is the respective blockchain is implemented by a registry which stores a plurality of NFDTs for a plurality of assets in the first country. For example a national carbon credit blockchain registry in country A may use a NFDT based blockchain registry in which carbon credit information for each asset in country A is represented by an NFDT on the blockchain. A trading system can also be created for the carbon credits to allow trading within the country (or potentially to other countries provided, transferability is addressed), and to include events such as retirement of carbon credits (e.g. in order to create CNTs). Similarly NFDT based registers can be used to record carbon liabilities (e.g. emissions) of assets, or carbon neutrality status of assets. These registries can then be linked, or associated trading platforms linked to enable cross-jurisdictional trading and offsetting taking into account transferability issues (and Paris Art 6 issues). In particular they allow creation of registries and trading platforms which allow NDC transferability or which prevent NDC transferability. NDC transferability could be at the discretion of the operator of the registry or trading platform, or left as an option of the owner of the asset (i.e. the asset owner can determine whether to allow or deny trading of the carbon credit across a national boundary.

FIGS. 1B to 1E, and 2A to 2E illustrate a trading exchange configured to record the carbon footprint attribute (ENV) value of an asset according to an embodiment. The trading system allows listing of assets and listing of the CNTs and a ledger is also used to store a carbon footprint attribute value (ENV) of each listed asset. The carbon footprint attribute value (ENV) for each listing traded on the digital asset trading exchange is tracked through the ledger, and the digital asset trading exchange is configured to provide an investor holding a portfolio of investments on the exchange with a portfolio value of the portfolio and a carbon footprint attribute value of the portfolio obtained by summing the carbon footprint attribute value of each investment in the portfolio of investments. Similarly the total carbon footprint attribute value (ENV) of an asset holder can be obtained by summing the carbon footprint attribute value of each listing, and any offsetting CNTs held to provide a mechanism to easily and clearly meet Environmental Social and Governance (ESG) reporting requirements.

Another application of the method is to create a trading platform or registry to allow entities to purchase carbon credits to create carbon neutral assets to prevent application of carbon levies under carbon border tax adjustments mechanisms (CBAM) proposed. For example the European Union, is developing a carbon border tax adjustments mechanisms (CBAM) to address problems of carbon leakage in which carbon intensive activities are performed outside of the EU in jurisdictions without carbon taxes and resulting products are then brought into the EU. Under the CBAM, the EU will impose a levy on an import if it is not a carbon neutral product equivalent to the carbon credits required to offset production of the product. The aim is thus to ensure traders in Europe are on a level playing field in relation to carbon neutrality status of a product so an offshore competitor cannot avoid the carbon tax they would face if the product was made in the EU. Thus in one embodiment a trading platform is established in a hub location between a source country and a destination country. For example Singapore is a major shipping hub through which many products pass as they are shipped from a various source countries and thus a registry could be established in this hub location. The registry would allow entities shipping product through the hub (i.e. through Singapore) to apply to have a NFDT created for the asset (the product) to determine the carbon neutrality status of the asset, and then purchase CNTs to offset any carbon emissions, and thus create a carbon neutral asset which is then shipped to the destination where the carbon neutrality status can be used to avoid imposition of a CBAM levy. The owner would go through the above described processes of submitting documentary evidence to determine the carbon footprint of the asset (e.g. the ENV value), which is then verified, and CNTs are then purchased through the exchange to offset the carbon footprint and this create a carbon neutral asset. Further as NFDTs are dynamic, they can be used to account for the actual number of products passing through the shipping hub over time. For example the carbon footprint of a single product could be determined (ENV₁), and recorded in the NFDT of the asset. Then further nodes could be created each time a shipment of N products arrive in the shipping hub capturing the number of products N, which thus have a footprint of N×(ENV₁). CNTs equivalent to N×(ENV₁) can then be purchased and the carbon neutrality status updated in the NFDT of the asset (e.g. a new node recorded in the blockchain for the asset). When the product arrives in the destination which would impose a CBAM levy, the NFDT record can be used to prove the carbon neutrality status of the asset.

NFDTs and trading systems may also be used for other live or dynamic digital assets. For example a media company or content creator may use embodiments of NFDT to track and monetise digital media or content, such as a news website, weekly column, or digital journal. The NFDT acts as a digital twin of the digital asset, with the birth contract storing relevant information about the digital asset. As content is updated or changed on the digital asset, for example a new daily column added, a subsequent asset contract is generated. In this case the subsequent information package may the additional content, for example in a PDF format.

In this embodiment we begin by documenting all the relevant information of the underlying media asset into an information package such as an offering memorandum in some prescribed format for review and approval. This may include relevant IP rights and economic interests available to investors. For example it may specify how much the media asset owner, the column reporters/episode producers and actors are each paid (for example as a percentage of revenue). The information package is then converted into a PDF file and we generate unique hash value from the PDF file. This hash value is used to verify the integrity of the PDF file and acts as its key identifier. The PDF file is uploaded to a website which also publish its related hash value.

The NFDT is then created using a series of smart contracts (for example based on ERC-721). The first or birth smart contract represents all the content at the time of issuance via the URL link to the PDF file and its hash value. As new media content is generated, such as a weekly news column or TV episodes, this is captured by a subsequent new smart contract that is linked to prior smart contract under the same NFDT. Thus, the NFDT of the news column or TV episodes represents the non fungible digital twin of the time series of digital content.

The NFDT is visible to the public in the Ethereum blockchain who will be able to access the PDF via the published URL. Whoever opens the link can use the PDF and hash value to test and verify authenticity of the NFDT.

We can further generate tradeable Media Asset Backed Tokens (Media ABTs) to monetise the NFDT. In this embodiment, rather than using an attribute to determine the number of ABTs to issue, the number to issue is determined by a book building method. Over time the digital asset may generate revenue, for example via advertising or subscriptions. In this embodiment the ABT smart contract, for example an ERC-20 based smart contract, will include the URL link to the PDF file and hash file. Each subsequent trade of the Media ABT will generate automatic payment to the media asset owner and the column reporters/episode producers and actors as described in the offering memorandum.

The ABT will be listed on a trading exchange such as a regulated financial asset exchange, and is capable of being traded by accredited and institutional investors. This is a step to safeguard that media owners, with a recurrent revenue, can always satisfy AML and other regulatory requirements of their revenue incomes. The public or investors can see the ABT in the Ethereum blockchain and will be able to access the PDF via the published URL.

In this one embodiment the digital asset is monetized via a book building process and subsequent trading of the ABTs on the exchange. For example the NFDT will be published and made available to investors during a digital road show. A book building model may be used to determine a price and a volume of ABTs. During the road show, interested investors will open an account at the exchange and submit their orders into to a book building module. At the end of the road show, the investors orders will be tabulated to determine the listing price and volume of the ABTs. The ABT smart contracts are written such that each subsequent trade will automatically generate a payment to the media asset owner. The media asset owner will then split the financial income between the owner and the specific media content creator e.g. reporter or writer based on the description in its offering memorandum. Since the asset owner might have kept a portion of the ABTs during the initial listing, any gain in the value of ABTs due to the secondary market trading can be divided between asset owner and the media content creator e.g. 20-50% split. In addition, since more and more content and digital assets are added to the NFDT, the media-ABTs are expected to appreciate with time as with more assets are added. This automatic payment feature and the potential gain in the ABTs generate higher revenue for the asset owner and incentivizes specific media content creators.

Embodiments enable asset owners to monetize their digital assets via the creation of a Digital Twin (NFDT) and associated ABT which can be sold to investors. Moreover, it enables the Digital Twin (NFDT) to be a living asset and extendable to capture all future media content. In addition, it allows the asset owner to improve its business model to be a recurrent revenue stream business model and find quantifiable and direct way to incentive its reporters in a more targeted way. The advantage to investors is that it allows them to invest and trade asset-backed tokens and the ability to authenticate the ABTs have a direct, permanent, immutable and verifiable link to the underlying media asset.

In another embodiment, the number of views of the digital asset (e.g. a video or website) may be stored as an attribute value of the asset. A subsequent asset contract is generated when a threshold number of additional views are recorded, or a subsequent asset contract may issue periodically such as each month and record the number of views over the monitoring time period (e.g. 1 month). This may then be used to calculate advertising revenue (e.g. on an amount per view basis).

The metaverse is proposed as digital representation of a plurality of real world assets. Thus in one embodiment NFDTs may be used as dynamic or live digital twins of the real world assets. NFDTs can be used to track time series of carbon footprints of real world assets (or objects) and form carbon asset/liability in the metaverse (or a specific metaverse).

In a real world pursuing carbon neutrality, an asset or object in the real world can have a series of carbon footprints calculated at different time periods (e.g. each year), for example by certification with standards such as ISO14064 and ISO 14067. This can be reflected by its NFDT in a Metaverse. Thus in each time period, if the asset reduces the world's carbon emission during that time period the NDT for that time period is created as a carbon asset and the amount recorded in the NFT, and if it emits carbon to the world during the relevant time period the NFT is created as a carbon liability and the amount recorded in the NFT. The NFDT representation of the asset in the Metaverse is thus comprises a sequential list of carbon assets and liabilities depending upon the carbon neutrality status of a given time period (e.g. each year).

In a Metaverse comprised of assets (or objects) with time series of carbon assets and carbon liabilities, CNTs can be used as an intermediary to pursue carbon neutrality, discharged by carbon assets and utilized by carbon liability to achieve neutralization.

CNT validity may be up to the earlier of world's carbon neutrality (e.g. 2050) or an international voluntary carbon neutrality standard will allow (such as PAS2060 which will later develop in to ISO standard). CNTs from carbon assets of different time period can then be utilized to neutralize carbon liabilities of different time period in a Metaverse. For example a first object may have a carbon liability at time k. A second object may have a carbon asset from a different time (t=3) and may be used to generate CNTs which are sold to the first object. If this is insufficient to lead to the carbon neutrality of the first object, CNTs may be obtained from a third object which had a carbon asset from at yet another time (t=2).

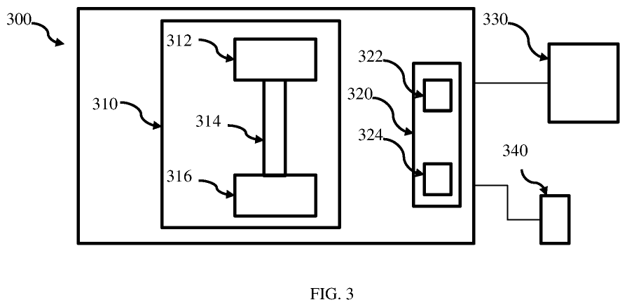

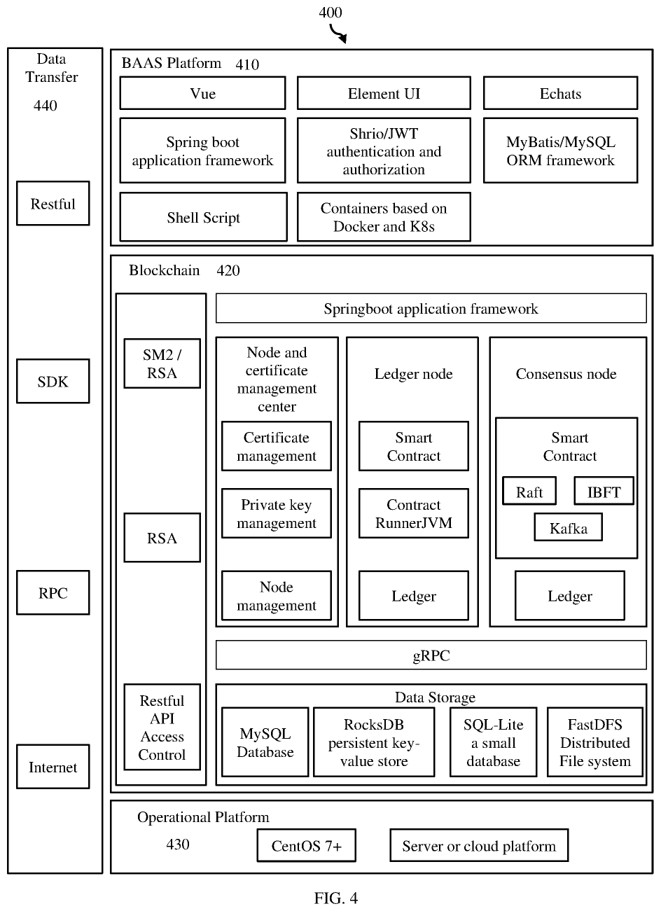

Implementations of embodiments of methods for generation of NFDTs and asset trading system may be implemented by computational system including one or more processors, one or more memories, one or more storage devices, and one or more interfaces configured to implement the method. The computational system may include the blockchain, such as a private blockchain or distributed ledger, or communicate with a public or external blockchain or distributed ledger. The trading platform may implement computational trading systems including a Nasdaq Next-Gen Trading and Matching Engine, a Nasdaq Risk Control Engine and a Nasdaq SMARTS surveillance engine. These may be implemented on local and/or cloud servers and interface with a public blockchain or implement a private blockchain or distributed ledger. In some embodiments the computational system includes a monitoring system (or multiple systems) using automated sensors and/or Internet of Things (IoT) devices configured to monitor and output an attribute of the real world asset. In some embodiments the monitoring systems may monitor computational systems or electronic document storage devices for lodgement or storing of new electronic documents related to the asset. In some embodiments secure computing apparatus and devices may be used, including secure computing apparatus for collecting information on the attribute of interest, and which may be configured to provide updates to trigger generation of a subsequent asset contract or which provides the information package for triggering generation of a subsequent asset contract. FIG. 3 is a schematic diagram of a computing apparatus (or computing platform) according to an embodiment for use in a secure data acquisition system. This may use a layered security model in the design of the operating system. FIG. 4 is schematic diagram of the technical architecture of the system including a blockchain based trading exchange according to an embodiment.

The generation of the NFDT requires measurement of the current value or change in value of one or more attributes. The measurement data may be obtained from a wide range of equipment/devices including internet of things (IoT) devices. For example in the carbon emission case the equipment may comprise gas detection equipment, gas flow meters, power meters, etc. In the case of tracking persons in a building video surveillance systems including facial and biometric recognition systems may be used. In the case of media data this may utilise software components which tracking the identity of users who access the content, devices used to access the content, other tracking metrics such as location.

In one embodiment measurements may be performed by a secure data acquisition platform to ensure authenticity and high levels of security and trust in the measurement data. The secure data acquisition platform comprises a plurality of hardware and software components which are developed and/or manufactured by, or under the control and certification of the system to ensure high levels of security and trust, or it may be independently manufactured and verified, and provide data to the system over secure communication links. Each system apparatus comprises a multi-layered security platform that uses specially manufactured trusted hardware and drivers, custom security-rich operating system to provide an enhanced security framework and utilities that block cyber-crime attack vectors providing limited attack surface, integrated Command and Control Centre to manage groups-driven device inventory and secured use policies, encrypted end to end (E2E) communications for protection against cavesdropping and wiretapping, security tools providing antivirus and AppsOps management, and a performance assurance toolset for seamless operation and security based on remote control technology and self-troubleshooting. Trusted hardware may be certified to Evaluation Assurance Level 7 (EAL7).

Embodiments may implement TrustZone technology which is a System on Chip (SoC) and CPU system-wide approach to security. TrustZone is hardware-based security built into SoCs to provide secure end points and a device root of trust. At the heart of the TrustZone approach is the concept of secure and non-secure worlds that are hardware isolated from each other. Within the processor, software either resides in the secure world or the non-secure world; a switch between these two worlds is accomplished by a secure monitor (application processors) or via hardware (microcontrollers). This concept of secure (trusted) and a non-secure (non-trusted) world extends beyond the CPU, its memory and software to include transactions on a bus, interrupts, and peripheral interfaces within a SoC. TrustZone technology for application processors is commonly used to run trusted boot and a trusted OS to create a Trusted Execution Environment (TEE). Typical use cases include the protection of authentication mechanisms, cryptography, key material and DRM. Applications that run in the secure world are called Trusted Apps. TrustZone technology for application processors provides a foundation for system-wide security and the creation of a trusted platform. Any part of the system can be designed to be part of the secure world including debug, peripherals, interrupts and memory. By creating a security subsystem, assets can be protected from software attacks and common hardware attacks. The partitioning of the two worlds is achieved by hardware logic present in the AMBA bus fabric, peripherals, and processors. Each physical processor core has two virtual cores: one considered secure and the other non-secure and a robust mechanism is provided to context switch between them (Secure Monitor Call). The entry to the secure monitor can be triggered by software executing a dedicated Secure Monitor Call (SMC) instruction or by a number of exception mechanisms. The monitor code typically saves the state of the current world and restores the state of the world being switched to.

This is further illustrated in FIG. 3 which shows a trusted computing apparatus 300, comprising one or more processors 310 each of which has two virtual cores: one secure core 312 and one non-secure core 316 and a context switch 314 which switches between the two cores. The apparatus further comprises one or more memories 320, which may further comprise a secure memory 322 associated with secure core 312 and a non-secure memory 324 associated with non-secure core 316. The computing apparatus may further comprise one or more input devices 330 and one or more output devices 340. In some embodiments a device may be both an input device and an output device (e.g. a touch screen). As noted above, the input and output devices may be secure or non-secure. Input devices 330 may include sensors, keyboards, mice, touchscreens, etc. Output devices may include a display device or a touch screen.

The one or more processors may be a central processing unit (CPU), graphical processing unit (GPU), microprocessor or microcontroller, and may comprise an Input/Output Interface, an Arithmetic and Logic Unit (ALU) and a Control Unit and Program Counter element which is in communication with input and output devices through an Input/Output Interface. The computing apparatus may also include a network interface and/or communications module for communicating with an equivalent communications module in another computing apparatus using a predefined communications protocol (e.g. WiFi, Bluetooth, IEEE 802.15, IEEE 802.11, TCP/IP. UDP, etc). The memory 320 is operatively coupled to the processor(s) 510 and may comprise RAM and ROM components, and may be provided within or external to the device. The memory may be used to store the operating system and additional software modules or instructions. The processor(s) may be configured to load and executed the software modules or instructions stored in the memory. Applications or computer programs for executing on the apparatus may be written in a general-purpose programming language (e.g., Pascal, C, C++, Java, Python, JSON, etc.) or some specialized application-specific language, and may utilise or call software libraries or packages as required. The operating system and application software may provide user interfaces.

In order to implement a secure world in the SoC, a trusted Operating System (Trusted OS) may be implemented to make use of the protected assets. The code implements trusted boot, the secure world switch monitor, a small trusted OS and trusted apps. Multiple levels of secure world privileges are provided for isolation between trusted boot, trusted OS and trusted apps. The combination of TrustZone based hardware isolation; trusted boot and a trusted OS make up a Trusted Execution Environment (TEE). The TEE offers the security properties of confidentiality and integrity to multiple Trusted Apps. Embodiments use high encryption levels and meet EAL7 certification.

In some embodiments system apparatus includes sensors and computational apparatus manufactured in a trusted environment. In this trusted environment all components are assembled and monitored under strict inspection policies enabling isolation of the hardware assembly process and the software installation process. Software installation is performed directly and exclusively by system experts in its system facilities. Controlling the manufacture of system sensors and computational apparatus further allows the entire device code, including drivers and bootloader to be controlled and owned. This enables the development of trusted drivers and a bootloader to enable secure boot and prevent the substitution of altered boot code (i.e. an “unauthorized replacement”) which might introduce malware or security backdoors into a processor once it is initialized. The apparatus may be configured to limit changeable boot parameters such as multi-stage boot code sourcing in the device as it loads, so that a malicious attack cannot interrupt the boot process and substitute false commands or security backdoors into the device setup. In one embodiment devices based on the IntactPhone platform may be developed, and drivers and the bootloader code can be fully audited. That is the system may be granted complete auditing access to the IntactPhone source code, including its drivers and bootloader to ensure security of system devices based on these devices. In one embodiment a self-destruction protection is implemented. In this embodiment a hardware date protected bootloader supports a unique data self-destruction mechanism wherein a self-destruction process is activated when a physical access attack is detected. In one embodiment system apparatus implement a secure operating system that focuses on security and fully protecting the device, not only from network attacks or malicious software but also from the user by enforcing strict organizations policies that the user can't bypass. In one embodiment this is based on a heavily customised Android version. In one embodiment a Total Shield approach is used, enabling a multi-layer security approach where each level is secured in different measures allowing the OS to eliminate even unknown threats, and which features improved resource management control in both kernel and driver levels for privacy sensitive resources.

Once data is collected, the data is processed by the system to estimate the attribute value or change in attribute value to enable generation of the NFDT and ABTs (if required).

FIG. 4 is schematic diagram of the technical architecture 400 of the system according to an embodiment. The technical architecture 400 consists of four components: a BAAS management and control platform 410, a blockchain 420, an operational platform 430 and a data transfer and communication module 440.

The Business As A service (BAAS) management and control platform 410 comprises front and back end frameworks. The main front-end frameworks and user interfaces are implemented using Vue, Element UI and Echarts whilst the back end is mainly a Spring boot application framework which is responsible for implementing Restful interface services. The Java security framework Shrio and the cross domain authentication solution JWT (JSON web token) are used to implement authentication, authorization, password and session management. MySQL is used as the database, and Mybatis is used as a data persistence mapping framework which supports customized SQL, stored procedures and advanced mapping. The BAAS platform uniformly manages and maintains the deployment of the underlying chain nodes. Shell script is used for the deployment of the underlying chain nodes, which can provide convenient and efficient functions in node deployment.

A blockchain 420 module is implemented in which the underlying chain is developed using the Springboot language framework along with a Certificate Authority (CA), a Peer/Ledger Node, and an Order/Consensus Node module. The node and certificate management centre (CA module) is responsible for node certificate management, private key management and node management. The peer (Ledger Node) module is mainly responsible for the initialization of smart contracts, data synchronization to the ledger storage, and maintenance. The order/Consensus Node is mainly responsible for the consensus of the whole network implementing consensus algorithms such as RAFT, IBFT and Kafka. It is also responsible for the landing of transaction data, the block packing to the ledger storage and maintenance. A high-performance RPC framework (e.g. gRPC) is used for communication. To provide security, asymmetric encryption is used for data transmission, and SSL encryption and authentication are used to authenticate the client accessing the message. In one embodiment RSA algorithm and domestic SM2 algorithms are used for signature and verification, and may also support International Des, domestic SM4, SM3 hash algorithm Sha256, Ed25519 signature algorithm. A data storage module supports/implements a MySQL database, a RocksDB database, a SQL lite small database and a FastDFS distributed file storage system.

The operational platform 430 implements a CentOS 4+ operating system for providing an execution (or running) environment for the BAAS platform and the blockchain and underlying chain nodes, which can run on specific physical machines (e.g. servers) or cloud platform. In one embodiment the system is designed and configured using trusted computing apparatus 500 as discussed above, or according to trusted security guidelines as discussed above to provide layered security throughout the system, such as use of encrypted data communications.

A data transfer and communication module 440 is configured to use SDK or RESTful to communicate with the underlying chain externally and gRPC to transmit data internally, and provides a communications interface to the Internet.

Embodiments of the above technical architecture may be used to create NFTs, NFDTs, and ABTs, and store the attribute values of an asset and enable trading. The above described technical architecture implements a trading exchange which includes a digital ledger that is able to track the attributes with the asset based on immutable data stored in a blockchain, and is able to clear and settle the trades on the trading exchange, with full tracking of the attribute value.

To summarise embodiments of methods and systems for generating dynamic Non-Fungible Digital Twin (NFDT) representations of real world assets (or objects) by using a time series of linked smart contracts on a blockchain that capture changes to the assets over time, such as changes in one or more specific attributes. In the context of the specification the NFDT is used as a digital twin of an asset. Asset is to be interpreted broadly and includes real assets or virtual assets. Assets may be objects and the terms can be used interchangeably. The asset (or object) will have some attribute or characteristic which changes over time, and may be a tradeable attribute (or characteristic).

The NFDTs and ABTs are created using specialised smart contracts published on the blockchain where the NFDT acts as an immutable digital twin of the asset to safeguard the authenticity of an attribute of interest, such as carbon footprint. In one embodiment the blockchain is an Ethereum blockchain and the smart contracts for the NFDT are based on ERC-721 smart contracts. However other blockchain and standards may be used. Each smart contract in the NFDT is different (irreplaceable), distinguishable, and by linking the smart contracts the NFDT's can track the attribute of interest over time. An NFT is uniquely identified by its contract address on the blockchain and a tokenID (a uint256) which provides a mapping to the address. A birth asset contract captures details of the asset via a link to an information resource and an attribute of interest. A time series of subsequent asset contracts can track changes in the asset, such as change in an attribute. These may store the current value of the attribute or a change attribute since the previous asset contract, and are linked (ultimately back to the birth asset contract) to enable tracking of the attribute over time. That is, after the birth contract, each subsequent asset contract stores the new attribute value at the present time (t) and along with the address of the previous smart contract (t-1). The use of stored information packages which are cryptographically signed enables the amount of content written to the blockchain to be minimised, and thus allows the digital twin of the asset to be a coarse representation containing only one tracked attribute and minimal identifying information, or it be a detailed representation in which many attributes are tracked and significant information documented.

Further Asset Backed Tokens, such as based on the Ethereum ERC-20 standard, may then be issued based on the change in the measured attribute and traded on an exchange or otherwise monetised. A digital asset trading system may be implemented which allows listing of assets and listing of the ABTs. The changes in an attribute can also be used to issue tradeable asset backed tokens (ABTs) which can be traded on a trading exchange, or ABTs may be generated based on other methods such as book building or other capital raising methods to assist in monetising an asset such as a digital asset. Tables 4 and 5 show example exerts of smart contract codes for generating the asset contracts (NFTs forming the NFDT) and asset backed tokens in the case of tracking carbon footprint. It will be understood this is illustrative, and the code could be suitably modified for other attributes.

In some embodiments the attribute is the carbon footprint or carbon neutrality status of the asset. Each asset smart contract includes the carbon footprint (e.g. tonnes of CO2 equivalent or simply tCO2e) generated since the last asset smart contract and is thus the carbon footprint (ENV) is bound to the digital asset. The carbon footprint attribute value (ENV) for each listing traded on the digital asset trading exchange is tracked through a ledger, and the digital asset trading exchange is configured to provide an investor holding a portfolio of investments on the exchange with a portfolio value of the portfolio and a carbon footprint attribute value of the portfolio obtained by summing the carbon footprint attribute value of each investment in the portfolio of investments. Similarly the total carbon footprint attribute value (ENV) of an asset holder can be obtained by summing the carbon footprint attribute value of each listing, and any offsetting CNTs held to provide a mechanism to easily and clearly meet Environmental Social and Governance (ESG) reporting requirements. The application of NFDT to carbon accounting provides methods for creating cross-border carbon credit trading mechanism without triggering NDC constraints and without dependence on Article 6 of Paris Agreement. In particular they allow the country in which emission reductions are occurring to record the reductions in their registries and to contribute to their NDC, and to freeze this reduction whilst allowing a digital representation of the asset or project to be created which can be freely traded across borders (whether by the original owner/offset or another party). Alternatively they allow the owner to control the transferability of the carbon credit (i.e. whether the credit can be traded across a national boundary). Emission reductions may also be permanently frozen and used to neutralize the carbon footprint of real world assets.

Embodiments of NFDT may be used to represent a real world asset in a virtual world such as the Metaverse. They may be used to track attributes such as carbon footprint or carbon neutrality status of an asset or a manufacturing process (e.g. for manufacturing a battery). They may also be used to track visitors to a building (the asset), or to monetise digital media or track viewing of digital media.

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software or instructions, middleware, platforms, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two, including cloud-based systems. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or other electronic units designed to perform the functions described herein, or a combination thereof. Various middleware and computing platforms may be used.

In some embodiments the computing apparatus may comprise one or more processors. The one or more processor may comprise one or more Central Processing Units (CPUs) or Graphical processing units (GPU) configured to perform some of the steps of the methods. Similarly a computing apparatus may comprise one or more CPUs and/or GPUs. A CPU may comprise an Input/Output Interface, an Arithmetic and Logic Unit (ALU) and a Control Unit and Program Counter element which is in communication with input and output devices through the Input/Output Interface. The Input/Output Interface may comprise a network interface and/or communications module for communicating with an equivalent communications module in another device using a predefined communications protocol (e.g. Bluetooth, Zigbee, IEEE 802.15, IEEE 802.11, TCP/IP, UDP, etc.). The computing apparatus may comprise a single CPU (core) or multiple CPU's (multiple core), or multiple processors. The computing apparatus is may be a server based computing apparatus or a cloud based computing apparatus using GPU clusters, but may be a parallel processor, a vector processor, or be a distributed computing device. Memory is operatively coupled to the processor(s) and may comprise RAM and ROM components, and may be provided within or external to the device or processor module. The memory may be used to store an operating system and additional software modules or instructions. The processor(s) may be configured to load and executed the software modules or instructions stored in the memory.

Software modules, also known as computer programs, computer codes, or instructions, may contain a number a number of source code or object code segments or instructions, and may reside in any computer readable medium such as a RAM memory, flash memory, ROM memory, EPROM memory, registers, hard disk, a removable disk, a CD-ROM, a DVD-ROM, a Blu-ray disc, or any other form of computer readable medium. In some aspects the computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media. In another aspect, the computer readable medium may be integral to the processor. The processor and the computer readable medium may reside in an ASIC or related device. The software codes may be stored in a memory unit and the processor may be configured to execute them. The memory unit may be implemented within the processor or external to the processor, in which case it can be communicatively coupled to the processor via various means as is known in the art.

Further, it should be appreciated that modules and/or other appropriate means for performing the methods and techniques described herein can be downloaded and/or otherwise obtained by computing device. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a computing device can obtain the various methods upon coupling or providing the storage means to the device. Moreover, any other suitable technique for providing the methods and techniques described herein to a device can be utilized.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

In one embodiment, a computer-readable storage medium is provided on which a computer program is stored, wherein the computer program implements the steps in each of the method embodiments described above when executed by a processor.

The reference to any prior art in this specification is not, and should not be taken as, an acknowledgement or any form of suggestion that such prior art forms part of the common general knowledge.

It will be understood that the terms “comprise” and “include” and any of their derivatives (e.g. comprises, comprising, includes, including) as used in this specification, and the claims that follow, is to be taken to be inclusive of features to which the term refers, and is not meant to exclude the presence of any additional features unless otherwise stated or implied.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

1. A method for generating a dynamic Non-Fungible Digital Twin (NFDT) representation of an asset, comprising the steps of:
generating and storing an information package at a report address, wherein the information package comprises information defining a digital twin of an asset including at least one attribute value;
cryptographically signing the information package and obtaining a hash for authenticating the information package;
generating a birth asset smart contract by inputting at least an asset identifier, the report address, and the hash of the information package to an asset smart contract stored on a blockchain which publishes the birth asset smart contract to the blockchain at a birth address and contains at least the inputted information and a non fungible token generated by the asset smart contract;
generating and storing at least one subsequent information package at a subsequent report address, wherein each subsequent information package comprises information regarding the asset including either a change in the at least one attribute value of the asset, or a current value of the at least one attribute value where each subsequent information package is generated at a different time;
cryptographically signing each subsequent information package and obtaining a hash for authenticating the subsequent information package; and
generating a plurality of subsequent asset smart contracts by inputting, for each subsequent information package, at least an asset identifier, the subsequent report address, and the hash of the subsequent information package to the asset smart contract stored on a blockchain which publishes a subsequent asset smart contract to the blockchain at a subsequent address and contains at least the inputted information, a non fungible token generated by the asset smart contract and a link to an address on the blockchain of a previous asset smart contract or the birth asset smart contract such that the published birth smart contract and one or more subsequent asset contracts form a time series of asset smart contracts which define a unique Non-Fungible Digital Twin (NFDT) representation of the asset.

2. The method as claimed in claim 1, wherein the report address is a Uniform Resource Identifier (URI) address or a Uniform Resource Locator (URL) address

3. The method as claimed in claim 1, wherein generating the birth asset smart contract further comprises inputting the at least one attribute value, and when generating each subsequent asset smart contract the change in the at least one attribute value of the asset, or a current value of the at least one attribute value is also input into the asset smart contract.

4. The method as claimed in claim 1, further comprising automated monitoring of the asset to detect a change in at least one of the at least one attribute value and either periodically or on detection of a threshold change, publishing a subsequent information package containing the change in the at least one attribute value or the current value of the attribute value which triggers publishing of a subsequent asset smart contract based on the update to the attribute value.

5. The method claimed in claim 1, wherein the at least one attribute value is a tradeable characteristic of the asset.

6. The method as claimed in claim 5, wherein after each subsequent asset smart contract is published the method further comprises generating a plurality of Asset Backed Tokens (ABTs) by executing a ABT smart contract stored on the blockchain, wherein an amount of ABTs issued is determined from the change in the at least one attribute value in the asset smart contract, or each ABT issued represents a fractional ownership of the NFDT and the underlying asset, and the ABT smart contract contains a link to the respective asset smart contract.

7. The method as claimed in claim 6, further comprising storing the plurality of ABTs and offering one or more of the plurality of ABTs for trading on a trading exchange.

8. The method claimed in claim 7, wherein the at least one attribute value is a carbon footprint of the asset and represents carbon emissions and/or carbon reductions measured in tonnes of CO2 equivalent (tCO2e), and the ABT is a carbon neutrality token (CNT) such that the NFDT is a digital twin of the underlying carbon credits applicable for trading.

9. The method as claimed in claim 8, wherein one or more of the information packages contains information regarding a carbon offsetting action in a first country, a carbon emission reduction certificate from an issuing authority in a first country in relation to the carbon offsetting action which generated an amount of verified carbon emission reductions, and a redemption certificate which prevents further trading of the carbon emission reduction certificate in an issuing country where the issuing country may be the first country or a different country.

10. The method as claimed in claim 9 wherein the method is implemented by a Carbon Registry which stores a plurality of NFDTs for a plurality of assets in the first country and which acts as the issuing authority.

11. The method as claimed in claim 5, wherein the at least one attribute value is a carbon footprint of the asset and represents carbon emissions and/or carbon reductions measured in tonnes of CO2 equivalent (tCO2e), such that the NFDT is a digital twin of the underlying carbon neutrality status of the asset, and wherein the method is implemented by a Carbon Registry which is further configured to issue voluntary emission reduction certificates and redemption certificates to an asset owner based on the NFDT of the respective asset.

12. The method as claimed claim 1, further comprising generating a plurality of Asset Backed Tokens (ABTs) by executing a ABT smart contract stored on the blockchain, wherein the ABT contains a link to the respective asset smart contract, and one or more of the plurality of ABTs are offered for trading on a trading exchange.

13. The method as claimed in claim 1, wherein each asset smart contract further includes an identifier of an owner of the asset and one or more of the at least one attribute values includes an attribute value related to a title or other proof of ownership by the owner.

14. The method as claimed in claim 1, wherein the NFDT is used to represent the asset in a Metaverse comprising a digital representation of a plurality of real world objects.

15. The method as claimed in claim 1, wherein the blockchain is an Ethereum blockchain, and the asset smart contract is based on the ERC721 standard.

16. A computational system comprising:
a plurality of computing apparatus comprising one or more processors, one or more memories, one or more storage devices, and one or more interfaces wherein the one or more interfaces are configured to:
generate and store an information package at a report address, wherein the information package comprises information defining a digital twin of an asset including at least one attribute value;
cryptographically signing the information package and obtaining a hash for authenticating the information package;
generating a birth asset smart contract by inputting at least an asset identifier, the report address, and the hash of the information package to an asset smart contract stored on a blockchain which publishes the birth asset smart contract to the blockchain at a birth address and contains at least the inputted information and a non fungible token generated by the asset smart contract;
generating and storing at least one subsequent information package at a subsequent report address, wherein each subsequent information package comprises information regarding the asset including either a change in the at least one attribute value of the asset, or a current value of the at least one attribute value, where each subsequent information package is generated at a different time;
cryptographically signing each subsequent information package and obtaining a hash for authenticating the subsequent information package; and
generating a plurality of subsequent asset smart contracts by inputting, for each subsequent information package, at least an asset identifier, the subsequent report address, and the hash of the subsequent information package to the asset smart contract stored on a blockchain which publishes a subsequent asset smart contract to the blockchain at a subsequent address and contains at least the inputted information, a non fungible token generated by the asset smart contract and a link to an address on the blockchain of a previous asset smart contract or the birth asset smart contract such that the published birth smart contract and one or more subsequent asset contracts form a time series of asset smart contracts which define a unique Non-Fungible Digital Twin (NFDT) representation of the asset.

17. The system as claimed in claim 16, wherein the report address is a Uniform Resource Identifier (URI) address or a Uniform Resource Locator (URL) address.

18. The system as claimed in claim 16, wherein generating the birth asset smart contract further comprises inputting the at least one attribute value, and when generating each subsequent asset smart contract the change in the at least one attribute value of the asset, or a current value of the at least one attribute value is also input into the asset smart contract.

19. The system as claimed in claim 16, wherein the one or more interfaces are further configured to periodically receive a change in the at least one attribute value or the current value of the attribute value from an automated monitoring system which monitors the asset and on receipt the one or more interfaces are configured to publish the subsequent information package containing the change in the at least one attribute value or the current value of the attribute value.

20. The system as claimed in claim 19, wherein the system further comprises the automated monitoring system and the automated monitoring system is a secure data acquisition system comprising a plurality of hardware and software components which are configured to securely monitor the asset.

21. The system as claimed in claim 16, wherein the at least one attribute value is a tradeable characteristic of the asset.

22. The system as claimed in claim 21, wherein after each subsequent asset smart contract is published the system is further configured to generate a plurality of Asset Backed Tokens (ABTs) by executing a ABT smart contract stored on the blockchain, wherein an amount of ABTs issued is determined from the change in the at least one attribute value in the asset smart contract, or each ABT issued represents a fractional ownership of the NFDT and the underlying asset.

23. The system as claimed in claim 22, further comprising a trading system implementing a ledger and cold wallet, wherein the trading system is configured to store the ABTs and facilitate trading of the ABTs between multiple parties.

24. The system as claimed in claim 23, wherein the at least one attribute value is a carbon footprint of the asset and represents carbon emissions and/or carbon reductions measured in tonnes of CO2 equivalent (tCO2e), and the ABT is a carbon neutrality token (CNT) such that the NFDT is a digital twin of the underlying carbon credits applicable for trading.

25. The system as claimed in claim 24, wherein one or more of the information packages contains information regarding a carbon offsetting action in a first country, a carbon emission reduction certificate from an issuing authority in a first country in relation to the carbon offsetting action which generated an amount of verified carbon emission reductions, and a redemption certificate which prevents further trading of the carbon emission reduction certificate in an issuing country where the issuing country may be the first country or a different country.

26. The system as claimed in claim 25, wherein the system is a Carbon Registry which is configured to store a plurality of NFDTs for a plurality of assets in the first country and which acts as the issuing authority.

27. The system as claimed in claim 21, wherein the at least one attribute value is a carbon footprint of the asset and represents carbon emissions and/or carbon reductions measured in tonnes of CO2 equivalent (tCO2e), such that the NFDT is a digital twin of the underlying carbon neutrality status of the asset, and the computational system forms part of a Carbon Registry which is configured to issue voluntary emission reduction certificates and redemption certificates to an asset owner based on the NFDT of the respective asset.

28. The system as claimed in claim 16, wherein the system is further configured to generate a plurality of Asset Backed Tokens (ABTs) by executing a ABT smart contract stored on the blockchain, wherein the ABT contains a link to the respective asset smart contract, and the system further comprises a trading system implementing a ledger and cold wallet, wherein the trading system is configured to store the ABTs and facilitate trading of the ABTs between multiple parties.

29. The system as claimed in claim 16, wherein each asset smart contract further includes an identifier of an owner of the asset and one or more of the at least one attribute values includes an attribute value related to a title or other proof of ownership by the owner.

30. The system as claimed in claim 16, wherein the NFDT is used to represent the asset in a Metaverse comprising a digital representation of a plurality of real world objects.

31. The system as claimed in claim 16, wherein the system further comprises the blockchain.

32. The system as claimed in claim 16, wherein the blockchain is an Ethereum blockchain, and the asset smart contract is based on the ERC721 standard.

33. A computer readable storage medium having a computer program stored thereon, the computer program implementing the method according to claim 1 when executed by one or more processors.
